(19) United States
(12) Patent Application Publication
(10) Pub. No.: US 2026/0061324 A1
(43) Pub. Date: Mar. 5, 2026

(54) SYSTEM AND METHOD FOR CONDUCTING AN INTERACTIVE SHOW

(71) Applicants: Jonathan Turcotte, Lac-Etchemin (CA); Sebastien Parlardy, Longueuil (CA)

(72) Inventors: Jonathan Turcotte, Lac-Etchemin (CA); Sebastien Parlardy, Longueuil (CA)

(21) Appl. No.: 19/317,288

(22) Filed: Sep. 3, 2025

Related U.S. Application Data
(60) Provisional application No. 63/689,882, filed on Sep. 3, 2024.

(51) Int. Cl. A63F 13/792; A63F 13/86; G06Q 20/36; G06Q 50/34; G07C 13/00

(52) U.S. Cl. CPC A63F 13/792; A63F 13/86; G06Q 20/3678; G06Q 50/34; G07C 13/00

(57) ABSTRACT

The present invention discloses a system and method for conducting an interactive show comprises a user device associated with one or more participants in communication with a television platform and a database comprises multimedia database, contestant data, audience data, and feedback data. A computing device is in communication with the database and the user device via a network. The computing device is configured to cast and manage show content, along with contestant activities and audience interactions. The computing device comprises an event configured to showcase individual talents to the audience. The computing device is configured to facilitate engagement of the participants with the events by casting votes using one or more tokens. The computing device is configured to adjust outcomes of the show based on the votes and feedback received from the participants in real-time. The computing device is configured to deliver time-bound objectives to engage and earn reward-based votes.

### CROSS-REFERENCE TO RELATED APPLICATION

This application claims the priority benefit of the U.S. Provisional Patent Application No. 63/689,882, titled “SYSTEM AND METHOD OF CONDUCTING A REALITY SHOW”, filed on Sep. 3, 2024, the contents of which are hereby incorporated by reference in their entirety.

### TECHNICAL FIELD

The present invention generally relates to broadcasting production. More specifically, the present invention relates to a system and method for conducting an interactive show.

### BACKGROUND

Traditional television platforms usually provide high-stimulation entertainment experiences tailored for viewers. The viewers could include the individual interested in gambling activity and individuals with dopamine-driven behaviors. The viewers increasingly seek multi-live content streams, faster-paced live interactions, and highly engaging livestream experiences that could be offered at little to no cost. The current platforms provide high-stimulation entertainment that not only satisfies an immediate psychological need but also serves as a strategic tool for cross-promotion. The platforms frequently promote other television series through algorithmic recommendations, integrated trailers, and targeted ads. Additionally, the platform integrates e-commerce elements including shoppable content, merchandise tie-ins, and embedded product placements. The integration helps to establish a unified ecosystem that not only keeps viewers engaged but also maximizes revenue opportunities across entertainment and retail channels.

In addition, current platforms are evolving to become starting points for individuals worldwide who aspire to become television professionals, including influencers, actors, or brand ambassadors. The aspiring professionals often look for fast, free, and accessible paths into the digital creator economy. The aspiring professionals are acquiring huge opportunities by using internet devices and live streaming to connect with people everywhere. While the platforms are beginning to successfully combine entertainment and e-commerce, many individuals still choose to avoid, ignore, or skip commercial content. Further, a few patent references related to the interaction systems are discussed as follows.

US20240040067 of Gathani Apurvi entitled “Method of Broadcasting Real-Time On-Line Competitions and Apparatus Therefor” discloses a live streaming method that enables organizers to broadcast real-time competitions or events over the internet with high-speed streaming and real-time voting, utilizing layered audio over a WebRTC channel. The method is fully developed using real-time communication protocols and is designed to support various user roles, including organizers, hosts, participants, and audience members. The platform delivers an interactive event experience by strategically synchronizing multiple live events occurring at one or more locations. Through the app, only the broadcaster, host, or organizer has the authority to initiate an event and retains full control over the operations. The method enables the host to invite multiple participants to join the live broadcast, which configures the WebRTC client roles for the participants. Additionally, the method enables the host to broadcast and record the event or competition from multiple camera angles using mobile devices including smartphones.

US20020198050 of Jeffery Patchen entitled “Viewer Interactive Event System” discloses an internet or phone polling system that provides audiences of competitive events the opportunity to interact with these events by determining which contestants may compete and the activities the contestants will perform. The audience might then judge the performance of each contestant by rating the performances. The audience members compete against one another by predicting the overall top-rated contestants. The audience members compete against one another while controlling and determining the outcome of the competitive events that are viewed. The system provides viewers as well as the contestants a chance to win awards, cash, and prizes as a result of their participation.

However, the existing platform provides access to the selected people to interact with the show and judge the outcome of the show. The platform primarily allows the viewers to passively engage by rating the performances of the contestant. Further, the aspiring professionals often face challenges in the current platform because most of the attention and opportunities go to individuals who are already well-established. The aspiring professionals further struggle to gain visibility and often find difficult to connect with the audiences. Additionally, the existing platform allows for self-broadcasting by a streamer, which benefits only the streamer and fails to provide benefit to the audience.

Therefore, there is a need for a system and method for conducting shows that enables access to all individuals including audience to interact with the show. The system needs to allow the audience to be engaged participants whose decisions and interactions could lead to the progression of the show and generate benefits to the audience. The system needs to provide opportunities to the new talents that would help the new talents to create a more inclusive, dynamic, and entertaining experience.

### SUMMARY

The present invention discloses a system for conducting an interactive show. The system comprises at least one computing device, one or more user devices, and at least one database. The computing device is in communication with the database and the user devices via a network. The user devices are associated with one or more participants in communication with a television platform. The participants include a promotion team member, a contestant, one or more commentators, a production team and one or more audiences. The audience is capable of voting for and against one or more contestants. The database comprises multimedia data, contestant data, audience data, and audience feedback data.

The computing device is configured to cast and manage show content, along with the contestant activities, and the audience interactions. The computing device further comprises an artificial intelligence (AI) module configured to curate show and event suggestions based on the activity of the participants. The AI module is further configured to enable adaptive challenges by customizing the experience of the audience based on engagement metrics. The AI module is further configured to suggest relevant shows, alliances, and events based on the behavior of the participants. The AI module is further configured to improve the experience of the participants with personalized content. The AI module is further configured to increase session duration and engagement of the participants.

The computing device further comprises at least one memory configured to store a set of program modules and at least one processor configured to execute one or more program modules. The modules comprise an event module, a wallet module, an interactive voting module, an augmentation module, a notification module, a participant interaction module, a mining and mini-game module, and a dynamic module.

The event module comprises one or more events. Each event comprises one or more contestants showcasing individual talents to the audience. The wallet module is configured to manage a diverse set of currencies and one or more digital assets. The currencies and the digital assets comprise one or more tokens, one or more gems, one or more cryptocurrencies, one or more non-fungible tokens (NFTs), and an inventory store. The wallet module is configured to manage votes and purchase items using the tokens. The wallet module is configured to manage points earned through engagement activities. The wallet module is configured to be utilized for purchasing minor rewards. The wallet module is configured to enable the participants to earn cryptocurrency through platform activities including purchases, mining, and secure transfer of the cryptocurrency to an external wallet. The wallet module is configured to manage ownership of the NFTs associated to the specific shows and the participants. The wallet module is configured to maintain the inventory store for storing bonuses, supplies, boosters, rewards, and rebates usable within the platform and across partner platforms. The wallet module comprises a cross-show currency system. The cross-show currency system is configured to enable tokens earned through participation in one show to be redeemed, transferred, and utilized across multiple franchises.

The interactive voting module is configured to facilitate dynamic engagement of the participants with one or more events by casting one or more upvotes and one or more downvotes using the tokens provided on purchasing a subscription. The interactive voting module is configured to enable real-time voting and provide visual feedback during the event. The interactive voting module is further configured to adjust outcomes of the show based on the votes and the feedback received from the participants. The interactive voting module is configured to aggregate votes of the participants instantly and displays the impact through one or more features. The features comprise a pop-up confirmation, one or more progress bars, a real-time adjustment, and an automated pre-vote.

The interactive voting module is configured to provide instant feedback via the pop-up confirmation. The interactive voting module is configured to display the cumulative impact of the voting effects via the progress bars. The interactive voting module is configured to enable real-time adjustment of the outcomes based on the ongoing participation of the participants. The interactive voting module is configured to enable the automated pre-vote process by placing the token in advance for upcoming events. The interactive voting module comprises one or more voting enhancement mechanisms. The voting enhancement mechanisms comprises a fast-track voting feature and a reward-based voting feature. The fast-track voting feature is configured to enable the participants to pay and avoid one or more time-based restrictions associated with voting actions. The reward-based voting feature is configured to allow participants to enter a real-world prize drawing based on the voting activity.

The augmentation module is configured to offer one or more power-up votes and a membership upgrade provided on purchasing the subscription. The power-up votes are configured to temporarily increase the voting power to enhance voting influence. The membership upgrade comprises one or more account types. The account types comprise a free account type, a basic account type, a premium account type, a very important person (VIP) account type, a promoter account type, and a celebrity account type. The augmentation module is further configured to enable the participants to unlock new ranks and skills upon achieving specific milestones in the show. The augmentation module is further configured to upgrade the participant profile by providing enhanced avatars, titles, and visual badges. The augmentation module is further configured to offer the participants exclusive items on a time-limited and event-based basis.

The augmentation module is further configured to enable one or more participants to access large token refills and enhanced features via the premium account. The augmentation module is further configured to enable high-level participants to unlock top-tier rewards and faster progression via the VIP account. The augmentation module is further configured to enable the contestants with a big fame to engage and influence the game using the promoter account, without claiming one or more benefits. The benefits include, but not limited to, prizes, money, and transfers.

The notification module is configured to manage one or more event calendars. The notification module is further configured to deliver timely updates and reminders to the participants. The notification module is configured to display scheduling information for an upcoming event and voting windows. The notification module is configured to send customizable alerts via a communication application.

The mining and mini-game module is configured to enable the participants to engage in a mini-game outside the television platform to earn daily rewards and one or more items. The mining and mini-game module is configured to allocate a central processing unit (CPU) or a graphics processing unit (GPU) resource for the cryptocurrency mining process. The mining and mini-game module is configured to manage the accumulation and automate the transfer of cryptocurrency earnings to the wallet module. The mining and mini-game module comprises one or more bet-style prediction games. Each bet-style prediction game is configured to allow the participants to predict outcomes and win one or more bonus tokens

The participant interaction module is configured to enable the participants to create private and public chat groups associated to the specific shows. The participant interaction module is further configured to access one or more sections dedicated to discussing various specific subjects related to the show. The participant interaction module is further configured to enable the participants to discuss show content, form alliances, and strategize on the voting process. The participant interaction module comprises a virtual reality (VR) system and an augmented reality (AR) system. The VR system is configured to enable the events to be experienced in immersive virtual reality delivering a futuristic viewing format. The VR system is configured to enhance emotional engagement. The AR system is configured to provide augmented reality overlays designed to introduce interactive elements to live events, including location-based rewards.

The dynamic module comprises one or more dynamic event challenges. The dynamic event challenges are configured to enhance the participants engagement and participation by presenting time-bound objectives including daily tasks, weekly tasks, and supplementary tasks. The dynamic module is further configured to present real-time polls comprising short and engaging questions during a live stream event to enable immediate participation of the audience. Further, the dynamic module is configured to implement wagering mechanics enabling the participants to wager tokens on the outcome of the contestant. The dynamic module is further configured to facilitate a barter system allowing participants to exchange one or more real-world items in a marketplace environment, thereby bypassing traditional currency-based transactions. The dynamic module comprises one or more seasonal theme events including holiday themed events. The seasonal theme events are configured to ensure the show content remains engaging and interesting to the audience. The seasonal event comprises a themed week configured to enable the audience to cast the vote on a weekly basis.

The dynamic module is further configured to personalize the content of the show by providing the audience with recommendations based on historical engagement, including past votes and participation data. The dynamic module is further configured to introduce a wildcard contestant into the competition based on the votes of one or more fans at mid-season. The dynamic module is further configured to enable the audience to vote for the contestants in a tournament-style progression format via an elimination bracket feature. The dynamic module is further configured to enable the audience to create fun side challenges via an audience-designed mini-game feature.

The dynamic module is further configured to allow the audience to swap the positions of two contestants within the game via a contestant switch-up feature. The dynamic module is further configured to enable the audience to vote on important decisions influencing the storyline, challenges, and contestant progression in real time. The contestant progression includes, but not limited to, a performance of the contestant, wins, user contributions for the contestant, and sponsorship opportunities provided to the contestant. The dynamic module is further configured to trigger a game-changing twist after a predefined number of episodes via a countdown to chaos feature. The dynamic module is further configured to introduce a hidden mechanic where some votes have the opposite effect via a reverse vote mechanic. The dynamic module further comprises one or more brand-sponsored in-show challenges configured to enable the audience to vote for the contestants to interact with a product of the respective brand. The brand-sponsored in-show challenges enable the participants to speed up the voting process.

The computing device further comprises a social engagement and community. The social engagement and community are configured to enable groups of friends to view the show simultaneously and cast votes together in real time. The social engagement and community are configured to allow influencers to provide real-time reactions and commentary during the show. The social engagement and community are configured to permit eliminated contestants to re-enter the competition based on audience support. The social engagement and community are configured to access and unlock exclusive content for dedicated fan bases. The social engagement and community are configured to allow the audience to compete based on the accuracy of the audience predictions regarding show outcomes.

The social engagement and community are configured to represent selected audiences as non-playable characters (NPCs) within the show environment. The social engagement and community are configured to generate competitive dynamics between audience groups supporting opposing contestants. The social engagement and community are configured to grant voting privileges to verified influencers. The social engagement and community are configured to display real-time audience comments on the screen during the broadcast. The social engagement and community are configured to trigger popular show-related memes circulating within the audience community.

The computing device is configured to utilize a voting tier mechanism to enhance voting power for the participants with a high engagement level. The computing device is further configured to enable the participants to gain compounding influence by accumulating power over multiple voting cycles using one or more cascading votes. The computing device is configured to enable to increase the voting power based on the duration of the engagement of the audience via a weighted voting system. The computing device is configured to enable the audience to use special power-up votes to activate effects including a double voting and a freeze vote.

The computing device is configured to automatically trigger the event upon detecting when a predetermined percentage of the audience casts the votes in the same way in majority rules mode. The computing device is configured to enable high-stakes voting by permitting the audience to wager tokens to influence significant events via a vote auction system. The computing device is configured to enable the contestant to request the audience to perform specific actions in exchange for a bonus using one or more contestant-endorsed votes. The computing device is configured to enable the audience to vote on challenges tailored to the individual contestants via one or more personalized challenge selections. The computing device is configured to enable the participants to purchase a personalized voting package offering customized voting options.

The computing device is further configured to enable the participants to purchase a one-time vote multiplier to increase vote weight during an important event. The computing device is further configured to enable the audience to boost the voting power by purchasing extra voting tokens. The computing device is further configured to utilize limited-time power-ups to temporarily increase the voting power. The computing device is further configured to enable the participants to purchase the tokens with a unique theme via a themed voting bundle. The computing device is further configured to enable risk-based voting to offer higher rewards when the chosen contestant wins. The computing device is further configured to enable the audience to temporarily block others from voting via a vote freeze power.

The computing device is further configured to lock certain votes irreversibly using strategic vote locks to enforce commitment. The computing device is further configured to enable the reversible votes to adapt based on evolving in-game scenarios. The computing device is further configured to enable the contestants to use special items to swap votes using a steal-a-vote ability. The computing device is further configured to enable the audience to solve a puzzle to unlock special voting privileges via a puzzle-based voting mechanism.

The computing device is further configured to enable the audience to receive a prize via a bingo-style voting reward on completing the predefined voting patterns. The computing device is further configured to enable a vote decay system to gradually reduce the power of cast votes over time unless each vote is actively reinforced by the audience. The computing device is further configured to provide an early vote bonus for the audience who votes early is granted with increased vote influence. The computing device is further configured to apply daily voting limits to restrict the number of votes the audience is allowed to submit per day.

The computing device is further configured to enable the audience to divide into one or more teams. Each team is capable of competing to influence different outcomes using one or more group voting challenges. The computing device is further configured to enable the random audience to decide crucial game events using a vote roulette. The computing device is further configured to enable voting via a wearable by registering smartwatch taps and gestures. The computing device is further configured to enable the contestants to request votes in exchange for in-game favors using a bribe mode.

The computing device is configured to enable the audience to join the platform with subscription and without subscription. The audience without subscription are allowed only to view the show and the audience with subscription are allowed to participate and interact with the show. The computing device is further configured to enable the audience to cast upvote and downvote for the contestant using one or more tokens. Further, the computing device is configured to enable the audience to position the predicted contestant on the expected outcome of one or more episode of each event. The computing device is further configured to enable the audience to cast votes to influence the progression of the event once the show begins, thereby increasing the likelihood of the predicted contestant winning and aligning with the expected outcome. The computing device is further configured to enable the audience to access one or more interactive features for continued engagement after each episode of the show. Further, the computing device is configured to enable the audience to receive the rewards upon achieving a perfect prediction of the contestant placements across all events.

The computing device is configured to enable the production team to present one or more trailers and an overall concept of the series to the audience. The computing device is further configured to enable the production team to store the production system records, edits, and uploads contender introductions. Further, the computing device is configured to enable the production team to create and release the first episode, which includes a short introduction of the concept. The computing device is further configured to enable the production team to record and apply the winning impact decisions received from the audience into upcoming episodes as fast as possible to decide the final prize. The computing device is further configured to enable the production team to organize small live events and conversation with the contenders and other participants for providing entertainment, hints, extra information, gossip, and drama to the audience. The computing device is further configured to enable the production team to deliver montages, extra footage, and group events to conclude the series, with additional challenges made available to encourage re-watching the series.

The computing device is configured to enable the contestant to apply for participation in the show. The computing device is further configured to enable the contestant to engage in one or more interview rounds and provide the introduction. The introduction provided is presented to the audience to select and reject the contenders. The contender is also referred as contestant in this specification. The selected contenders are allowed to participate in the first episode and the rejected contenders are prompted to provide a short interview reflecting on their experience. The computing device is further configured to enable the contestant to participate in challenges for each episode and the impact of the audience votes to positively or negatively affect contender outcomes. The challenges comprise short talks, live mini-challenges, and interactive events to entertain the audience in between episodes while ensuring the contenders remain active throughout. The computing device is further configured to enable the contestant to receive the rewards based on the contestant progression including performance, wins, user contributions, and sponsorship opportunities.

In one embodiment, a method for conducting an interactive show is disclosed. The system comprises at least one computing device, one or more user devices, and at least one database. The computing device is in communication with the database and the user devices via the network. The user devices are associated with one or more participants in communication with the television platform. The participants include the promotion team member, the contestant, one or more commentators, the production team, and one or more audiences. The audience are capable of voting for and against one or more contestants. The database comprises multimedia data, contestant data, audience data, and audience feedback data. The computing device is configured to the computing device is configured to cast and manage show content, along with the contestant activities, and the audience interactions.

At one step, the computing device is configured to facilitate the participation of one or more participants in one or more live polls and quizzes during live shows. The polls and quizzes are configured to provide real-time interaction between participants and audience feedback. At another step, the computing device is further configured to enable the participants to place wagers on the performance of a contestant and a show outcome using one or more tokens. The wagering introduces risk-reward dynamics and creates monetization opportunities. At yet another step, the computing device is further configured to provide a non-fungible token (NFT) marketplace for the participants to buy, sell, and trade the contestants based on one or more themed NFTs representing digital collectibles and in-show privileges. The NFTs establish blockchain-based ownership and generate a new revenue stream. The computing device is further configured to enable the audience to cast both upvote and downvote against the contestant to impact the progression of the event.

At yet another step, the computing device is further configured to support competition of the participant on one or more leaderboards based on engagement metrics. The rewards are granted to recognize top contributors and promote competition. At yet another step, the computing device is further configured to allow the audience to influence the storyline of the show, challenges, and contestant progression through voting for the contestant. At yet another step, the computing device is further configured to deploy the AI module to recommend relevant shows, alliances, and events based on the behavior of the participant. The AI module is configured to enhance the experience of the participants with personalized content.

At yet another step, the computing device is further configured to allow the participants to share the achievements, the votes, and the livestream links on an external platform. The external platform is configured to expand reach and encourage viral marketing of the show. At yet another step, the computing device is further configured to facilitate the participant to earn one or more rewards through referrals of one or more new participants, thereby fostering a network effect for community growth. At yet another step, the computing device is further configured to integrate a voice command to enable the participant to interact for voting and engagement purposes.

At yet another step, the computing device is further configured to provide split-screen viewing for the participants to view multiple shows and camera angles simultaneously for multi-perspective engagement. At yet another step, the computing device is further configured to allow the participants to rewatch past shows with interactive voting history and challenges to extend content lifespan and offer learning opportunities. At yet another step, the computing device is further configured to incorporate the live commentary during events to deliver insights, enhance engagement, and enable to provide premium content to the participants.

At yet another step, the computing device is further configured to provide access to the participants to view the data via a dashboard and profiles displaying participation statistics, voting impact, and engagement metrics. At yet another step, the computing device is further configured to permit the participants to send tokens, items, and virtual gifts to the contestants. At yet another step, the computing device is further configured to enable the participants to complete the provided dynamic event tasks to earn rewards. At yet another step, the computing device is further configured to facilitate the participants to play skill-based mini-games to earn rewards through engagement and optionally permit crypto mining to earn additional tokens. At yet another step, the computing device is further configured to permit the participants to join teams to compete in voting challenges and in-game events. At yet another step, the computing device is further configured to activate one or more seasonal themes based on real-world events to drive participation, and facilitate promotional campaigns.

At yet another step, the computing device is further configured to allow the participants to engage in in-app surveys regarding show features, directions, and new ideas to provide feedback and increase overall engagement. At yet another step, the computing device is further configured to offer the participants an option to purchase shields or insurance against votes via a voting protection feature. The voting protection feature comprises a strategic layer that enhances the in-game economy. At yet another step, the computing device is further configured to encourage the participants to collaborate in teams to complete challenges and in-game events to unlock rewards. At yet another embodiment, the computing system is configured to support the participants to switch between live events without leaving the user interface and provide gamified onboarding for new participants to reduce onboarding friction and encourage immediate engagement.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 exemplarily illustrates an environment of a system for conducting an interactive show, according to an embodiment of the present invention.

FIG. 2 exemplarily illustrates a block diagram of the computing device of FIG. 1.

FIG. 3 exemplarily illustrates a flowchart of a method for conducting an interactive show, according to an embodiment of the present invention.

FIG. 4 exemplarily illustrates a flowchart of the method for voting, according to an embodiment of the present invention.

FIG. 5 illustrates a table showing an outcome of the multiple contenders positioned across a series of events according to voting of the audience, according to an embodiment of the present invention.

FIG. 6 exemplarily illustrates a flowchart of a method for selecting and rewarding a contestant, according to an embodiment of the present invention.

FIG. 7 exemplarily illustrates a flowchart of a process involved in a production team, according to an embodiment of the present invention.

### DETAILED DESCRIPTION OF EXAMPLE EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

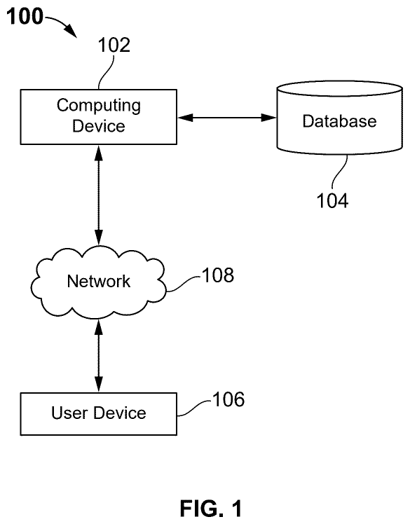

Referring to FIG. 1, an environment 100 of a system for conducting an interactive show comprises at least one computing device 102, at least one database 104, and one or more user devices 106. The computing device 102 is in communication with the database 102 and the user devices 106 via a network 108. The user devices 106 are associated with one or more participants in communication with a television platform. The participants include a promotion team member, a contestant, one or more commentators, a production team and one or more audiences. The audience is also referred to as a voter or a voter audience throughout the specification. The audience is capable of voting for and against one or more contestants. The contestant includes, but not limited to, a content creator, an influencer, a celebrity, and a public figure. The promotion team member includes, but not limited to, partners and advertisers.

The user device 106 is configured to provide an interface to access the services provided by the computing device 102. The interface, for example, is an application that allows the user device 106 to wirelessly connect and access the computing device 102 via the network 108. The user device 106 includes, but not limited to, a desktop computer, a laptop computer, a mobile phone, a personal digital assistant, and the like.

The network 108 generally represents one or more interconnected networks, over which the computing device 102, the user device 106 and the database 104 could communicate with each other. The network 108 may include packet-based wide area networks (such as the Internet), local area networks (LAN), private networks, wireless networks, satellite networks, cellular networks, paging networks, and the like. A person skilled in the art will recognize that the network 108 may also be a combination of more than one type of network. For example, the network 108 may be a combination of a LAN and the Internet. In addition, the network 108 may be implemented as a wired network or a wireless network or a combination thereof.

In an example, the database 104 resides in the computing device 102. In another example, the database 104 resides separately from the computing device 102. Regardless of the location, the database 104 comprises a memory to store and organize data for use by the computing device 102. The database 104 comprises information related to the multimedia data, contestant data, audience data, and audience feedback data for use by the computing device 102.

In one embodiment, the computing device 102 is at least one of a server, a general-purpose computer, a special-purpose computer, a workstation, a desktop, a laptop, a tablet, a mobile phone, a mainframe, a supercomputer, and a server farm. Although the computing device 102 is illustrated as a single device, the functions performed by the computing device 102 could be performed using any suitable number of computing devices 102. The computing device 102 is configured to cast and manage show content, along with the contestant activities, and the audience interactions. The computing device 102 further comprises an artificial intelligence (AI) module. The artificial intelligence (AI) module is configured to curate show and event suggestions based on the activity of the participants. The AI module is configured to enable adaptive challenges by customizing the experience of the audience based on engagement metrics. The AI module is configured to suggest relevant shows, alliances, and events based on the behavior of the participants. The AI module is configured to improve the experience of the participants with personalized content. The AI module is configured to increase session duration and engagement of the participants. The AI module is configured to enhance the discovery of lesser-known shows.

The computing device 102 comprises one or more events. Each event comprises one or more contestants showcasing individual talents to the audience. The computing device 102 is configured to manage a diverse set of currencies and one or more digital assets. The currencies and the digital assets comprise one or more tokens, one or more gems, one or more cryptocurrencies, one or more non-fungible tokens (NFTs), and an inventory store. The computing device 102 is configured to vote and purchase items using the tokens. The purchased Items are non-refundable which ensures platform revenue integrity.

The computing device 102 is configured to support gems as a premium currency for high-value transactions. The computing device 102 is configured to manage points earned through engagement activities and is usable for minor rewards. The computing device 102 is configured to enable the participants to earn cryptocurrency through platform activities including purchases, mining, and secure transfer of the cryptocurrency to an external wallet module. The computing device 102 is configured to enable ownership of NFTs linked to specific series, shows, stars, and participants. The computing device 102 is configured to maintain an inventory for storing bonuses, supplies, boosters, rewards, and rebates usable within the platform and across partner platforms. Further, the computing device 102 is configured to ensure secure transactions and transparent tracking for all wallet activities.

The computing device 102 is configured to facilitate dynamic engagement of the participants with one or more events by casting one or more upvotes and one or more downvotes using the tokens provided on purchasing a subscription. The computing device 102 is configured to enable real-time voting and provide visual feedback during the event. The computing device 102 is further configured to adjust outcomes of the show based on the votes and the feedback received from the participants. The computing device 102 is configured to aggregate votes of the participants instantly and display the impact through one or more features. The features comprise a pop-up confirmation, one or more progress bars, a real-time adjustment, and an automated pre-vote. The computing device 102 is configured to provide instant feedback via the pop-up confirmation. The computing device 102 is configured to display the cumulative impact of the voting effects via the progress bars. The computing device 102 is configured to enable real-time adjustments by adjusting the outcomes based on the ongoing participation of the participants. The computing device 102 is configured to enable the automated pre-vote process by placing the token in advance for upcoming votes. This system is scalable, supporting thousands of concurrent votes without latency.

The computing device 102 is configured to offer one or more power-up votes and a membership upgrade provided on purchasing the subscription. The power-up votes are configured to temporarily increase the voting power to enhance voting influence. The membership upgrade comprises one or more account types. The account types comprise a free account type, a basic account type, a premium account type, a very important person (VIP) account type, a promoter account type, and a celebrity account type. The free account type is configured to enable basic access with limited features. The basic account type is configured to provide the audience with low monthly token refills, reduced timers, and enable access to more features.

The premium account type is configured to support and engage the participants by offering higher monthly token refills, further reduced timers, and enabling access to more features. The very important person (VIP) account type is configured to cater to top-tier participants seeking elevated status, increased chances of winning, ranking, and leveling up. The promoter account type is configured to provide the promotion team members with weekly and monthly special tokens for promotional use. The promoter account might participate but is unable to claim prizes, withdraw funds, or transfer assets. The promoter account is configured to enable influencers and public figures to engage without risk. The celebrity account type is configured to accommodate high-profile contestants by reflecting the public impact. The celebrity account type is further configured to enable scalable returns and influence within the platform.

The computing device 102 is configured to provide temporary power-ups to enhance voting influence. The computing device 102 is configured to enable a title claim to unlock new ranks and skills upon achievement. The computing device 102 is configured to upgrade the profile by providing enhanced avatars, titles, and visual badges. The computing device 102 is configured to offer exclusive items on a time-limited and event-based basis.

The computing device 102 is configured to manage one or more event calendars. The computing device 102 is further configured to deliver timely updates and reminders to the participants. The computing device 102 is configured to display scheduling information for an upcoming event and voting windows. The computing device 102 is configured to send customizable alerts via a communication application. The communication application includes, but not limited to, an email, a short message service (SMS), and in-platform notifications. The computing device 102 is configured to provide countdown timers for the events. The computing device 102 is configured to support push notifications. The computing device 102 is configured to integrate with a third-party application. The third-party application could be a google calendar.

The computing device 102 is configured to enable the participants to engage in a mini-game outside the television platform to earn daily rewards and one or more items. The computing device 102 is configured to allocate a central processing unit (CPU) or a graphics processing unit (GPU) resource for the cryptocurrency mining process with an option to disable the feature. The computing device 102 is configured to manage the accumulation and automate the transfer of cryptocurrency earnings to the wallet. The computing device 102 is configured to unlock titles and ranks directly related to mini-game achievements, effectively combining mining and gameplay for dual engagement.

The computing device 102 is configured to enable the participants to create private and public chat groups associated to the specific shows. The computing device 102 is configured to access one or more sections dedicated to discussing various specific subjects related to the show. The specific subjects could be hype, gossip, leaks, hacking, support issues, and bugs. The computing device 102 is configured to enable the participants to discuss show content, form alliances, and strategize on the voting process. The computing device 102 is further configured to pool resources for collective influence on outcomes.

The computing device 102 comprises one or more dynamic event challenges configured to enhance the participants engagement and participation by presenting time-bound objectives including daily tasks, weekly tasks, and waiting period fill-ins. The computing device 102 is further configured to present real-time polls comprising short and engaging questions during a live stream event to enable immediate participation of the audience. Further, the computing device 102 is configured to implement wagering mechanics enabling the participants to wager tokens on the outcome of the contestant. The computing device 102 is configured to support a crown founder wagering by enabling the participants to place real-money or virtual currency stakes with emphasis on high-stakes engagements. The computing device 102 is further configured to facilitate a barter system allowing participants to exchange one or more real-world items in a marketplace environment, thereby bypassing traditional currency-based transactions.

The system further comprises one or more live polls and one or more quizzes. The system is configured to enable the participants to participate in real-time polls and quizzes during live shows. The system is further configured to collect immediate feedback from the audience. The system is further configured to increase engagement and retention of the participants by conducting quizzes and live poll. The system is further configured to allow content creators to assess the sentiment of the participants.

The system further comprises a real-time wagering system. The system is configured to allow the participants to place wagers using platform tokens on contestant's performances or on the show outcomes. The system is configured to introduce excitement through risk-reward dynamics to engagement. The system is further configured to provide an additional monetization channel. The system is further configured to promote strategic decision-making among the participants.

The system further comprises an NFT marketplace. The system is configured to allow the participants to buy, sell, and trade NFTs. The NFT is associated with contestants, themes, or team-based groups. Further, the NFTs are linked to in-show privileges and digital collectibles. The system is configured to introduce blockchain-based ownership and exclusivity. The system is further configured to offer a new revenue stream for the content creators. The computing device is further configured to enable the audience to cast both upvote and downvote against the contestant to impact the progression of the event. The system is further configured to add collectible and tradable assets to the ecosystem.

The system further comprises a leaderboard reward. The system is configured to rank the participants based on engagement metrics and reward. The engagement metrics include voting, sharing, and participation. The system is further configured to encourage competition and activity of the participants. The system is further configured to recognize and reward top contributors. The system is further configured to increase retention by providing long-term incentives.

The system further comprises a dynamic show path mechanism. The dynamic show path mechanism is configured to allow the audience to vote on important decisions that influence the storyline, challenges, and contestants' progression. The system is configured to provide a sense of control and co-creation. The system is further configured to enhance replay value through multiple possible outcomes. The system is further configured to boost the emotional investment of the audience.

The system further comprises a contestant sponsorship feature. The contestant sponsorship feature is configured to allow the participants to sponsor contestants by providing the contestants with voting power and in-game advantages. The system is configured to build the audience-contestants connection. The system is further configured to create an additional monetization model. The system is further configured to encourage long-term engagement.

The system further comprises a social media sharing feature. The system is configured to enable the participants to share achievements, votes, and live stream links to an external platform. The system is configured to expand the visibility and reach of the platform. The external platform is configured to encourage viral marketing, and incentivizes the participants through referral bonuses.

The system further comprises a referral program. The referral program is configured to reward the participants for inviting new contestants to the platform. The system is configured to drive the participants acquisition organically. The system is further configured to create a network effect for community growth. The system is further configured to provide incentives for the loyalty of the participants.

The system further comprises a voice interaction interface. The voice interaction interface is configured to allow the participants to vote or engage with the platform using voice commands. For example, the command could be “vote contestant A” or “vote contestant A.” The system is further configured to improve accessibility for disabled participants. The system is further configured to enhance convenience for the participants. The system is further configured to add a futuristic touch to engagement. The system is further configured to ensure that the vote is securely tied to the authenticated participants.

The system further comprises a split-screen viewing feature. The split-screen viewing feature is configured to allow the participants to watch multiple shows and one or more camera angles simultaneously. The system is further configured to increase engagement by offering multiple perspectives of the shows. The system is further configured to enable the participants to follow different storylines in one session. The system is further configured to provide a competitive edge over traditional streaming platforms.

The system further comprises a voting tier feature. The voting tier feature is configured to grant higher-tier participants enhanced voting power based on engagement or purchases. The system is configured to encourage spending and higher participation. The system is further configured to reward the active participants with greater influence. The system is further configured to enhance strategic gameplay within the platform.

The system further comprises a merchandise auction feature. The merchandise auction feature is configured to enable the participants to bid on exclusive items related to contestants or the show. The system is configured to drive excitement and urgency. The system is further configured to generate revenue from unique and limited-time offerings provided to the participants. The system is further configured to create an internal economic system within the platform.

The system further comprises an event replay feature. The event replay feature is configured to enable the participants to rewatch past shows with interactive voting history displayed or with new challenges related to the events. The event replay feature is configured to extend the lifespan of the show content. The system is configured to help new participants catch up on previous event, and promote learning and strategy development for competitive elements.

The system further comprises a live commentary feature. The live commentary feature is configured to provide expert insights and real-time reactions during live events. The live commentary feature is configured to add professional analysis and engagement. The live commentary feature is further configured to offer premium content for the high-tier participants. The live commentary feature is configured to enhance the competitive environment of the platform.

The system further comprises an event analytics feature. The event analytics feature is configured to display specific data of the participants including voting history, individual impact, and participation statistics. The event analytics feature is further configured to encourage competitive engagement. The event analytics feature is further configured to provide strategic insights for future interactions. The event analytics feature is further configured to reward the participants with achievement-based performance metrics.

The system further comprises a virtual reality (VR) streaming feature. The VR streaming feature is configured to allow the participants to watch events in an immersive VR environment. The VR streaming feature is further configured to create a next-generation entertainment experience. The VR streaming feature is further configured to increase immersion and emotional connection. The VR streaming feature is further configured to offer an alternative viewing method.

The system further comprises a personalized event creation feature. The personalized event creation feature is configured to enable the participants to create custom mini-shows with audience participation. The personalized event creation feature is further configured to encourage participant-generated content. The personalized event creation feature is further configured to allow smaller communities to form and grow. The personalized event creation feature is further configured to expand engagement possibilities.

The system further comprises an augmented reality (AR) integration feature. The AR integration feature is configured to overlay augmented reality elements onto live shows. The AR integration feature is further configured to enhance gamification. The AR integration feature is further configured to provide location-based bonuses, easter eggs, codes, or gifts via temporary portals. The AR integration feature is further configured to make the experience more interactive. The AR integration feature is further configured to provide additional advertising and branding opportunities.

The system further comprises a gifting system feature. The gifting system feature is configured to allow the participants to send virtual gifts, tokens, or items to contestants or friends. The gifting system feature is further configured to enable the participants to purchase items from a Wishlist within the store. The gifting system feature is further configured to encourage social interactions. The gifting system feature is further configured to create new revenue streams. The gifting system feature is further configured to strengthen contestant-fan relationships.

The system further comprises a dynamic event challenges feature. The dynamic event feature is configured to allow the participants to complete tasks in special events to earn rewards. The dynamic event challenges feature is further configured to support single, daily, weekly, monthly, or timed challenges. The system is further configured to encourage consistent participation. The system is further configured to add excitement and unpredictability. The system is further configured to provide a skill-based component.

The system further comprises a skill-based mini-games feature. The skill-based mini-games feature is configured to enable the participants to play games with in-platform rewards. The system is further configured to allow, to mine crypto from the GPU or the CPU and get tokens for each specific amount of crypto mined. The system is further configured to encourage casual and competitive play. The system is further configured to add entertainment beyond passive watching. The system is further configured to increase time spent on the platform and fill time between episodes or series.

The system further comprises a team-based competition feature. The team-based competition feature is configured to allow the participants to join teams and compete in voting challenges or in-game events. The system is further configured to enable to be crown founder by the audience participating in the event using tokens or money. The system is further configured to enable the winners to split the amount of money in the poll while the platform retains a commission. The system is further configured to strengthen community engagement. The system is further configured to provide structured group activities and enhance cooperative strategy mechanics.

The system further comprises a seasonal theme feature. The seasonal theme feature is configured to introduce themed events based on real-world seasons or holidays. The system is further configured to keep content fresh and relevant. The system is further configured to encourage limited-time participation. The system is further configured to provide promotional tie-ins.

The system further comprises a hidden unlockable feature. The hidden unlockable feature is configured to include easter eggs and secret achievements within events. The system is further configured to increase exploration and engagement. The system is further configured to reward dedicated participants. The system is further configured to create a viral mystery-solving effect. The system is further configured to rewatch the episodes or shows.

The system further comprises a multi-stream support feature. The multi-stream support feature is configured to allow the participants to switch between different live events without leaving the main page. The system is further configured to improve the retention of the participants. The system is further configured to allow multitasking within the platform. The system is further configured to reduce drop-off rates.

The system further comprises an interactive tutorial feature. The interactive tutorial feature is configured to provide gamified onboarding guides for the new participants. The system is further configured to reduce the learning curve. The system is further configured to increase the confidence and participation of the participants. The system is further configured to encourage immediate interaction.

The system further comprises an in-app surveys feature. The in-app surveys feature is configured to collect feedback regarding the show direction, features, or new ideas from the participants. The in-app surveys feature is further configured to provide valuable market insights. The in-app surveys feature is further configured to help tailor content to the preferences of the audience. The in-app surveys feature is further configured to increase the engagement of the participants.

The system further comprises a voting protection feature. The voting protection feature is configured to allow the participants to purchase shields or insurance to protect their votes from counter-votes. The system further includes different levels of shields that could be destroyed by a superior level of attack on the vote. The system is further configured to add a strategy layer to voting. The system is further configured to enhance the in-game economy. The system is further configured to encourage premium spending.

The system further comprises a collaborative challenges feature. The collaborative challenges feature is configured to allow participants to complete team-based activities to unlock rewards. The system is further configured to strengthen social bonds. The system is further configured to encourage cooperation. The system is further configured to provide structured, goal-based engagement.

In one embodiment, the system further comprises advanced audience participation and voting mechanics. The system includes live polls with timed decisions that enable the audience to vote on challenges in real time before a countdown expires. The system includes hidden votes that remain secret until revealed in a big twist moment. The system further comprises a cascading voting system that allows votes to accumulate power across multiple rounds for compounding influence. A weighted voting system increases the power of the vote of the audience based on how long the audience has been watching the reality show. The system comprises a special power-up vote that could be accessed by the audience to enable unique effects including doubling the vote or freezing the vote. In the majority rules mode, the event is triggered automatically when a predefined percentage of the audience votes is identical.

The system comprises a vote reversal feature that allows the contestants to retract or modify votes within a limited window. The system includes a voting by region where the votes are based on the city or country of the audience. The voting by region might allow a regional showdown or increase power increased for people in a region. The system includes a percentage-based voting impact that allows the contestants to receive bonuses proportional to vote percentages. A vote auction system introduces high-stakes voting that allows the audience to bid tokens to influence bigger events. The system includes a black market. The black market comprises an underground aspect of the platform that enables the audience to leverage the vote, but when the audience loses then the loss will cost them more.

In one embodiment, the system comprises an interaction feature for interaction between the contestants and the audience. The interaction feature is configured to support real-time contestant appeals that allow the contestants to send a video message to the audience. The interaction feature is further configured to support live chat with contestants which enable limited-time chat sessions between contestants and the premium audience. The interaction feature is further configured to support personalized votes by allowing the audience are able to send custom messages with the votes. The interaction feature is further configured to support a social media voting boost that allows the audience to share the link of the show to get extra votes. The interaction feature is further configured to implement a fan loyalty ranking that allows the audience who consistently vote for the contestants to gain special advantages. The interaction feature is further configured to support contestant-endorsed votes that enable the contestants to request specific audience actions for bonuses.

The interaction feature is further configured to support voting with emotions that allows the audience to express feelings either as votes or as a vote bonus. The feelings include, but not limited to, anger, excitement, or happiness. The interaction feature is further configured to support spectator chat groups, where the audience creates one or more micro-communities within the platform. The interaction feature is further configured to provide VIP voter access, offering exclusive behind-the-scenes content access. The behind-the-scenes content includes private videos, secret hints, or giveaways 2-3 win out of 50+ elements. Additionally, the interaction feature is configured to include an elimination rescue feature that allows the fans to save the contestants from elimination with enough votes.

The system comprises a customization and personalization feature. The customization and personalization feature are configured to support the creation of a custom audience avatar that allows the participants to create a digital persona that evolves based on engagement. The customization and personalization feature are further configured to support personalized challenge picks that allow the audience to vote on challenges designed specifically for contestants. The customization and personalization feature are further configured to allow personal victory goals that enable the audience to set predictions and earn points when the audience's predictions are accurate. The customization and personalization features are further configured to provide customizable in-game items that allow the audience to unlock and customize virtual accessories. The customization and personalization features are further configured to deliver personalized content feeds by recommending content based on the past voting actions of the audience.

The customization and personalization features are configured to support selectable difficulty levels for certain challenges, with higher rewards granted for more difficult options. The customization and personalization features are further configured to allow dynamic UI skins that enable the audience to change the interface based on the interactions of the audience. The customization and personalization features are further configured to present adaptive challenges that are automatically adjusted by an artificial intelligence (AI) based on the engagement of the audience. Further, the customization and personalization feature enable the allocation of personalized power-ups that offer unique advantages based on the participation history of each audience. The customization and personalization feature supports community-driven challenge design that allows the audience to propose challenge ideas and the best are implemented.

The system comprises a show dynamics and challenge twist feature. The show dynamics and challenge twist feature are configured to support one or more mystery challenges where the audience is not aware of the consequences of the votes until later. The show dynamics and challenge twist feature are further configured to support wildcard contestants who were surprise entries chosen by fan votes mid-season. The show dynamics and challenge twist feature are further configured to facilitate elimination brackets, where the vote of the audience is used in a tournament-style progression. The show dynamics and challenge twist feature are further configured to allow themed weeks, with weekly show themes selected by audience votes. The system comprises a “steal a vote” feature configured to enable the contestants to use special items to swap votes.

The show dynamics and challenge twist feature comprise an audience-designed mini-game that enables the audience to create fun side challenges. Additionally, the show dynamics and challenge twist feature are configured to support contestant switch-ups that allow the audience to exchange the positions of two contestants in the game. A countdown to chaos feature introduces major game-altering twists after a predetermined number of episodes. The show dynamics and challenge twist feature are configured to enable reverse votes, a hidden mechanic where certain votes produce the opposite effect.

The system comprises asocial engagement and community feature. The social engagement and community feature is configured to support live watch parties that allow groups of friends to watch and vote together. The feature is further configured to include a commentary mode that enables the influencers to deliver reactions in real time during episodes. The system comprises a redemption island feature that allows eliminated contestants to return to the competition based on the support of the audience. The feature also includes secret fan club access; dedicated fan bases unlock exclusive content. The system comprises a live prediction leaderboard configured to enable the audience to compete for the most accurate predictions.

The feature further enables one or more viewers as virtual characters or NPCs within the show's narrative. The viewer is also referred to as the audience. The feature further supports fan-based rivalries where the groups compete to support opposing contestants. The feature further comprises an influencer voting tier where the famous influencers get special voting privileges. The feature further includes a crowd-sourced commentary where the live audience messages appear on screen during broadcasts. Further, the feature includes “meme power” boosts, where popular show-related memes could trigger in-game events.

The system comprises a progression and rewards feature. The progression and rewards feature are configured to include a level-up system where the audience earns experience points (XP) by watching, voting, sharing, and promoting the show, with a ranking leaderboard for each element. The progression and rewards feature are further configured to award achievement badges by unlocking digital badges for specific milestones. The progression and rewards feature include a daily login bonus that provides returning participants with free tokens or advantages. The progression and rewards feature comprise one or more challenge streaks where consecutive voting participation unlocks bonuses including a percentage increase in power each time or an increased chance of a higher power strike. The progression and rewards feature include a mystery box rewards system that offers random prize drops for engaged participants.

The progression and rewards feature support exclusive fan voting tournaments, creating private challenges for the active audience. The progression and rewards feature support a social media sharing perk that provides additional rewards for promoting the show online. The progression and rewards feature support seasonal challenges are introduced as limited-time events with unique prizes. The progression and rewards feature support a premium voting subscription model where paid members get additional influence. The feature includes loyalty rewards for long-time fans to provide a special advantage for veteran community members.

The system comprises an interactive viewer action feature. The interactive viewer actions feature is configured to support a virtual reality mode, where the audience experiences challenges from the perspective of the contestants. The interactive viewer actions feature is further configured to support an augmented reality (AR) voting that enables the audience to interact with show elements via AR. The interactive viewer actions feature is further configured to include a “Live Director” feature, where certain audiences are temporarily granted directorial control over specific scenes. The interactive viewer actions feature is further configured to allow the audience to create mini-challenges by enabling short, interactive events during the show. The interactive viewer actions feature is further configured to support an unlockable soundboard command that triggers fun audio effects.

The interactive viewer actions feature is further configured to provide dynamic camera angles, where the audience could switch between multiple camera feeds. The interactive viewer actions feature is further configured to enable emoji-triggered events, where high volumes of audience reactions activate special on-screen effects. The interactive viewer actions feature is further configured to support personalized contestant coaching, where the audience sends motivational messages. The interactive viewer actions feature is further configured to support the spectator-activated special effects including lighting changes, fog, or music shifts. The interactive viewer actions feature is further configured to include audience-sponsored obstacles that allow the audience to introduce real-time challenges for the contestants.

The system comprises advanced monetization and earning features for enhancing revenue streams. The monetization and earning features are configured to include in-app purchases and virtual goods. The in-app purchases and virtual goods support premium voting tokens that allow the audience to purchase extra voting tokens to gain stronger voting power. The monetization and earning features are further configured to offer limited-time power-ups that enhance votes for short durations. The monetization and earning features are further configured to support custom digital merchandise, including avatars, skins, and virtual outfits related to the show. The monetization and earning features are further configured to support themed voting bundles, which enable to buy tokens with unique themes including sports edition and battle royale edition. The monetization and earning features are further configured to support one-time vote multipliers that allow the audience to pay to increase the weight of a vote during an important event.

The monetization and earning features are further configured to support exclusive NFT collectibles linked to show events. The monetization and earning features are further configured to support a token subscription plan where monthly packages offering tokens and exclusive content. The monetization and earning features are further configured to support a season pass for VIP participants that allows to unlock premium votes, challenges, and behind-the-scenes content. The monetization and earning features are further configured to support personalized voting packages that allow the participants to pay for customized voting options. The option includes sabotage-only votes. The monetization and earning features include an unlockable mystery box that offers randomized digital prizes or voting boosts.

The monetization and earning features include sponsorship and brand collaboration. The collaboration is configured to support sponsored voting events where the brands sponsor the voting rounds with product tie-ins. The collaboration is further configured to support advertiser-sponsored tokens that enable the audience to watch advertisements in exchange for free voting tokens. The collaboration is further configured to include branded contestant gear that offers special outfits or accessories designed in collaboration with brand partners. The collaboration is further configured to enable themed sponsored challenges, where brands sponsor in-show challenges, for example, Red Bull. The collaboration further supports a live product placement that allows the audience to vote for the contestants to interact with branded products during the show. They are further configured to support influencer and celebrity-sponsored votes, in which the celebrities encourage the audience to vote using a branded feature.

The collaboration is further configured to support retail store token integration, where purchasing real-world products gives digital voting tokens. The collaboration is further configured to offer co-branded in-game items, including exclusive branded digital collectibles. The collaboration is further configured to support virtual billboard ads where the advertisers pay to have logos displayed during voting sequences. The collaboration is further configured to include branded power-ups including special effects including a Coca-Cola “energy boost” that speeds up the votes.

The monetization and earning features comprise a gamified monetization mechanic. The gamified monetization mechanics are configured to support leaderboard sponsorships where the brands sponsor top-ranking voters with special prizes. The gamified monetization mechanics are further configured to support referral-based token rewards that allow the audience to earn voting tokens by inviting friends to join the platform. The gamified monetization mechanics are further configured to offer daily login streak rewards where the participants are rewarded with the tokens for maintaining consecutive daily logins. The gamified monetization mechanics are further configured to support milestone unlockable, where the participants unlock premium content by reaching a specific voting milestone.

The gamified monetization mechanics are further configured to include a loyalty points exchange that enables the audience to convert long-term engagement into redeemable rewards. The gamified monetization mechanics are further configured to offer contestant-specific supporter packs that allow the fans to purchase premium perks tied to the favorite contestants. The gamified monetization mechanics are further configured to include live auction voting that allows the participants to bid premium tokens to increase the impact of the votes. The gamified monetization mechanics are further configured to support voting challenges with cash prizes that enable the audience to complete interactive missions to win real money. The gamified monetization mechanics are further configured to enable time-limited special votes, where the audience pays to access exclusive high-impact votes that expire after use. The gamified monetization mechanics are further configured to support wager-style prediction games that allow the participants to predict the outcomes to win bonus tokens.

The monetization and earning features comprise pay-to-access premium content. The pay-to-access premium content supports an exclusive live stream for paying participants that enables them to unlock question and answer sessions of the contestants and behind-the-scenes content. The pay-to-access premium content supports a “second screen” experience, where premium subscribers receive real-time data and analytics related to voting. The pay-to-access premium content is further configured to offer an ad-free experience subscription that allows the audience to remove advertisements from the voting process. The pay-to-access premium content is further configured to provide VIP show endings that allow the premium members to access the alternate endings of the challenge.

The pay-to-access premium content includes a behind-the-scenes documentary access that showcases the production process of the show. The pay-to-access premium content is further configured to support exclusive reality show cuts that enable the audience to pay for extended or alternate versions of episodes. The pay-to-access premium content is further configured to offer unlockable past season footage, making archived content available to paying participants. The pay-to-access premium content is further configured to provide an artificial intelligence (AI) generated personalized recaps that enable the subscribers to receive the customized video recap of the favorite contestants of the audience. The pay-to-access premium content is further configured to include a director's commentary mode that provides a premium access to insights from the show's creators. The pay-to-access premium content is further configured to support a fast-track voting pass that allow to pay and avoid time restrictions on select voting actions.

The system further comprises prize and reward-based monetization. The prize and reward-based monetization includes a real-money contest that enables the participants to pay an entry fee for the chance to win real cash prizes. The prize and reward-based monetization is further configured to support limited-time grand prize pools that allow the paying participants to enter jackpot-style prize draws. The prize and reward-based monetization is further configured to include an achievement-based reward system that allows the audience to earn digital badges and unlock monetary bonuses. The prize and reward-based monetization includes a user-generated voting rounds, where the audience pay to submit the challenge of the audience or contestant ideas. The prize and reward-based monetization is further configured to support a “fantasy league” for contestants that allows the audience to create teams and place token-based wagers on their success.

The prize and reward-based monetization includes a special event ticket sale, where the audience pays for VIP access to in-person finale events. The prize and reward-based monetization includes a raffle ticket voting, in which the selected votes enter the participants into real-world prize drawings. The prize and reward-based monetization includes cashing out digital rewards that allow the participants to convert the virtual earnings into one or more physical goods. The prize and reward-based monetization is configured to support a cross-show currency system, in which the tokens earned in one show to be used across multiple franchises. The prize and reward-based monetization includes a fan investment system that allows the audience to pay back specific contestants and earn rewards when the same contestant wins.

The system further comprises monetization and earning features. The monetization and earning features are configured to include in-game advertiser quests, where the sponsored challenges are for product placements. The monetization and earning are further configured to support live ad voting that allows the audience to choose which advertisement plays next, with incentives, for example shorter ad durations or early skip options. The monetization and earning features are further configured to include sponsored power-ups that enable the brand to provide in-game bonuses. The monetization and earning features are further configured to offer limited-time sponsorship deals that allow the audience to unlock brand rewards, discounts, and bonus tokens.

The monetization and earning features are further configured to support brand-specific contestant costumes, with special outfits selected through audience voting. The monetization and earning features are further configured to support an e-commerce integration that allows the audience to purchase show-related merchandise within the app. The monetization and earning features are further configured to include product unlock tokens that represent collectible in-game items tied to real-world purchases. The monetization and earning features are further configured to support NFT-based contestant merchandise that provides access to limited-edition digital collectibles. The monetization and earning features are further configured to include a “watch & earn” system that allows the participants to earn rewards for engaging with advertisements. The monetization and earning include a “play & earn” system that enables the audience to play mini-games and receive rewards, including crypto tokens and small NFTs. The monetization and earning features are further configured to support exclusive pay-to-vote rounds that provide limited premium voting events.

The system further comprises bonus and endgame features. The bonus and endgame features are configured to include secret endings unlocked by the audience, where the hidden storylines are revealed through voting activity. The bonus and endgame features are further configured to support fan-made alternate endings, in which the audience votes to determine the outcome of the season finale.

The bonus and endgame features are further configured to include a hall of fame for the top voters that offers long-term recognition for the most active contestants. The bonus and endgame features are further configured to support a hall of fame for top community contributors that recognizes the highly engaged audience who act as ambassadors within the community. The bonus and endgame features are further configured to enable AI-generated season recaps, where highlight reels are customized for the audiences and repackaged with votes. To see their best moment and have a title as “Editor” based on community votes. The bonus and endgame features are further configured to support multi-season carryover effects that allow votes to influence future seasons. The bonus and endgame features are further configured to include crossover events with other shows, where the special episodes feature multiple franchises.

The bonus and endgame features are further configured to support live award ceremonies, where the audience votes on the best moments of the season. The bonus and endgame features are further configured to include a secret contestant vote that allows the audience to select a surprise contestant to join the competition at the last minute. The bonus and endgame features are further configured to support global fan challenges where the audience participates in real-world events that have a direct impact on the progression of the show.

The system further comprises advanced audience participation and voting mechanics. The advanced audience participation and voting mechanics comprise advanced voting types & structures. The advanced voting types and structures include ranked choice voting which allows the audience to rank multiple contestants to influence elimination probabilities. The advanced voting types and structures are further configured to support cumulative voting which enable the unused votes to roll over to future rounds when the votes are not used immediately. The advanced voting types and structures are further configured to include a negative voting mode that allows the audience to vote against the contestants and increase the likelihood of elimination. The advanced voting types and structures are further configured to implement auto-balance voting, ensuring no contestant receives excessive advantages. The advanced voting types and structures are further configured to support token-based weighted voting, where additional tokens increase the influence of each vote. The advanced voting types and structures are further configured to include a secret majority vote, which triggers hidden actions automatically when 51% of the votes support the hidden action.

The advanced voting types and structures are further configured to support a tie-breaker fan vote that provides the audience a rapid-decision vote in case of a tie. The advanced voting types and structures are further configured to include global vs. regional voting that offers bonus voting power to the audience who are supporting the contestants from the same region of the audience. The advanced voting types and structures are further configured to implement progressive influence voting, where the power of votes increases with the audience engagement over time. The advanced voting types and structures are further configured to support a flashback vote where previously eliminated contestants are returned based on audience selection.

The advanced audience participation and voting mechanics include time-sensitive and event-based voting. The time-sensitive and event-based voting includes a speed voting round where the limited-time voting windows force fast decisions. The time-sensitive and event-based voting are further configured to support overtime vote battles that allow an additional voting round in closely contested matchups. The time-sensitive and event-based voting is further configured to include scheduled power votes, in which some votes could only be cast at specific times. The time-sensitive and event-based voting are further configured to implement a vote decay system that causes the votes to lose the power over time unless reinforced.

The time-sensitive and event-based voting are further configured to support instant elimination mode, where the contestant is removed immediately when the threshold of negative votes is met. The time-sensitive and event-based voting are further configured to offer early vote bonuses that provide the audience who votes early is granted with increased vote influence. The time-sensitive and event-based voting are further configured to include a vote freeze power that allows the select audience to block others from voting temporarily. The time-sensitive and event-based voting is further configured to enforce daily voting limits that control how many votes the audience could submit each day. The time-sensitive and event-based voting are further configured to enable rebound voting that permits the audience to modify the votes within a limited time frame. The time-sensitive and event-based voting are further configured to support surprise voting rounds that introduce unannounced voting opportunities for added unpredictability.

The interactive and gamified voting experiences are configured to include interactive voting mini-games, enabling participants to earn voting power by playing casual games. The interactive and gamified voting experiences are further configured to support puzzle-based votes, requiring participants to solve puzzles to unlock special voting privileges. The interactive and gamified voting experiences are further configured to include live trivia voting, where correct answers increase vote strength. The interactive and gamified voting experiences are further configured to enable surprise lucky votes, granting randomly selected voter's additional influence. The interactive and gamified voting experiences are further configured to include bingo-style voting rewards, offering prizes for completing voting patterns.

The interactive and gamified voting experiences are further configured to support voting through augmented reality, where scanning OR codes allows participants to cast votes. The interactive and gamified voting experiences are further configured to integrate VR-enhanced decision making, enabling immersive voting for VR participants. The interactive and gamified voting experiences are further configured to include vote roulette, where randomly selected audiences to decide critical game events. The interactive and gamified voting experiences are further configured to support reaction-based voting, using facial expressions or voice recognition to determine vote strength. The interactive and gamified voting experiences are further configured to include one or more group voting challenges, allowing teams of the audience to compete for control over outcomes.

The vote manipulation and influence mechanics are configured to include vote stacking, where the participants save up votes for high-impact moments. The vote manipulation and influence mechanics are further configured to support bribe mode, where contestants may request votes in exchange for in-game favors. The vote manipulation and influence mechanics are further configured to include sabotage tokens that the audience could use to weaken another contestant's vote count. The vote manipulation and influence mechanics are further configured to support vote splitting, enabling votes to be distributed across multiple contestants. The vote manipulation and influence mechanics are further configured to include a steal-a-vote ability, randomly allowing one user to take influence from another.

The vote manipulation and influence mechanics are further configured to support reversible votes, where vote outcomes could be changed based on game events. The vote manipulation and influence mechanics are further configured to include hidden vote options, keeping certain votes secret until a critical reveal moment. The vote manipulation and influence mechanics are further configured to support strategic vote locks, preventing certain votes from being changed once cast. The vote manipulation and influence mechanics are further configured to enable risk-based voting, providing higher rewards when a chosen contestant wins. The vote manipulation and influence mechanics are further configured to include power shift votes that allow the audience to transfer their vote power to another player at any point.

The system also comprises cross-platform and social media engagement features that extend voting beyond the core application. The cross-platform and social media engagement features are configured to support social media voting boosts, increasing vote impact when shared online. The cross-platform and social media engagement features are further configured to include hashtag voting that allow the participants to cast votes by posting specific hashtags. The cross-platform and social media engagement features are further configured to support a leaderboard of top voters, displaying the most active participants in a ranking system. The cross-platform and social media engagement features are further configured to enable exclusive votes for streamers, allowing platforms including a TWITCH and a YOUTUBE to host unique audience-powered voting. The cross-platform and social media engagement features are further configured to support influencer voting challenges, where celebrities and content creators guide audience votes in real time.

The cross-platform and social media engagement features are further configured to include voting via wearables, enabling smartwatches and gesture-based inputs to register votes. The cross-platform and social media engagement features are further configured to support public vs private voting modes, where votes could be either anonymous or visible to the community. The cross-platform and social media engagement features are further configured to allow multiple voting channels, enabling participation through TV, mobile apps, smart devices, and social media. The cross-platform and social media engagement features are further configured to provide live-event voting bonuses, granting special voting power to attendees of real-world events. The cross-platform and social media engagement features are further configured to support offline pre-show voting, where fans influence the upcoming season by casting early votes for contestant advantages.

The computing device 102 is configured to calculate a number of positive votes minus a number of negative votes against each of the one or more participating contestants to generate a voter rating for each of the one or more participating contestants. The vote could be received in the form of video, photo, text, music, email, voice, and a combination thereof. In an exemplary embodiment, the vote is either a positive vote for at least one of the one or more participating contestants or a negative vote against at least one of the one or more participating contestants. The legitimacy of the winner needs to be verified by the production house or any other third-party company to avoid fake account registration or non-legitimate action in the process. To be able to show transparency and show that the winners have won in a legitimate way.

In an exemplary embodiment, a winner of the reality program is for at least one of the one or more participating contestants having the highest voter rating. Further, the audience could also win by guessing the right element of the show, it means the viewers could influence here and there to force the result they bet on. The contestant could win by performing more than others in the activities of events. For example, a challenge is a race with 5 contestants and ex100 million (M) audience. The winning contestant is the one who wins the race. They can win it by running faster than others. The bet for the viewer is 50000$ to guess who will be the last one and they could untie the shoes of someone or add a weight belt, and replace shoes with something better or worse, all of this with votes or tokens.

The contestant is able to win the prize or the challenge of the events by following the rules of the game, not by having a lot of votes. There is no link between the votes for a contestant and being the winner of the contest or TV show. There is no link between the winner of the TV show and the winner of the bet on the TV show. The winning contestant will win the grand prize by being the most engaged or performant through the rules of the TV show/game. The voter rating of the audience is influenced based on one or more tokens associated with one or more voter audiences selected from one or more voter audiences. The casting competition is influenced based on one or more tokens associated with one or more audiences selected from one or more voter audiences. In an embodiment, the reality program is displayed on different medias, selected from an adequately and functionally connected TV set, internet that is able to reach certain website, radio, and a hand-held device that is able to receive and send an e-mail, to receive and send text messages and to interact successfully and adequately with any other media where the reality program is broadcasted. The number of episodes of a reality show is not limited to find the winner and the number of episodes is based on the number of participants in the reality program, or on other requirements and rules of the reality program. In an exemplary embodiment, every episode of a reality show has its own rules and requirements and has the same or different content from another episode.

Every episode of the reality show has its own rules and requirements and has the same or different content from another episode. Embodiments of the present invention are described herein in the context of a system, method, and apparatus for producing a program. The invention includes a reality television, internet, or other media-based program that assesses the viability of a program, minimizes financial risk, generates advertising revenue prior to production; generates advertising for the production prior to studio commitment; creates a refined set of potential cast members for a casting call; and creates a built-in fan base of the show, all prior to production. The inventive system, method, and apparatus uses a social network and or a computer network to attract potential candidates and voters. A calculation and processing analysis based upon elements gleaned from a number of input and output factors is utilized to assess the viability and potential success of the reality program to serve as a predictor of whether or not the program will move forward to full production and airing.

In the interest of clarity, not all the routine features of the implementations described herein are shown and described. It will be appreciated that in the development of any such actual implementation, several implementation-specific decisions must be made to achieve a production team, studios, or a one producing a program's specific goals, including compliance with application and business-related constraints, and that these specific goals will vary from one implementation to another and from one entity to another. Development of the network and linking the input calculation means, databases, output, and results values may be a routine undertaking of engineering for those of ordinary skill in the art based upon the disclosure herein.

A program in the inventive embodiments could be a television, radio, Internet, mobile, or cellular based show of any length; and preferably it is a reality program for television. The internet as used herein might be a collection of interconnected networks including public and private networks that are linked together by a set of standard protocols. The standard protocols include, but not limited to, a Transmission Control Protocol/Internet Protocol (TCP/IP) and Hypertext Transfer Protocol (HTTP) to form a global and distributed network. While this term is intended to refer to what is now commonly known as the Internet, it is also intended to encompass variations that may be made in the future, including changes and additions to existing standard protocols.

The user interface or interface might be any mechanism by which an external individual or the external computer could obtain and provide data, respectively to or from the database of the present invention. For example, the interface could be a website. Other examples might include an e-mail message, a telephone voice message, or a paper report. Voter rating is a calculation of the number of positive votes for a potential candidate minus the number of negative votes against a potential candidate.

A social network might be an aggregation of individual social relationships that occur via an interface. A website as used herein may be a computer system that serves informational content over a network using the standard protocols of the World Wide Web. As used herein, the term is generally intended to encompass both (i) the hardware/software server components that serve the informational content over the network, and (ii) the “back end” hardware/software components, including any non-standard or specialized components, that interact with the server components to perform services for website users.

Turning now to a discussion of the drawings, a plurality of interfaces are presented from a plurality of different entities such as the production team, one or more potential candidates, and one or more voter candidates capable of inputting and receiving information via various different interfaces such as any device capable of presenting data, including, but not limited to, personal computers, cellular telephones, television sets, or hand-held “personal digital assistants,” in connection with a computer network associated with a server.

As used herein, the term “computer network” generally refers to any public or closed collection of distinct networks working together to appear as a single network to a user, including the Internet or the public world wide web of various connections, connected to each other using the Internet protocol (IP) and other similar protocols. The Internet can provide information about the program, transfer files, receive information, provide information, allow remote login, and provide electronic mail and mail services.

As described herein, the exemplary network of FIG. 1 is for descriptive purposes only. Although the description may refer to terms commonly used in describing public networks such as the Internet, the description and concepts equally apply to other public and private computer networks, including systems having architectures similar to and dissimilar from that shown in FIG. 1.

For example, and without limitation thereto, the system of the present invention can find application in public as well as private networks, such as the private network of a production company, talent agency, and or studio. The arrows and connections provided indicate the flow of information to and from the plurality of different entities such as the production team, one or more potential candidates, and one or more voter candidates in the inventive methods and systems of casting and pre-production of a reality program.

As used herein, the production team includes the casting team, the studio, the network, or other entity associated with the program that assists in the pre-production stages of the program. The general architecture of a system according to one or more embodiments of the invention including at least one server hosting a website displaying reality program guidelines and a casting competition in communication over a network with one or more potential candidates, one or more voter candidates, and the production team, and including a database storing baseline popularity measurements, a potential candidate database, a voter candidate database, and a database engine.

As will be appreciated by those skilled in the relevant art(s), the configurations of the systems and the methods within the illustrated figures are flexible and can be modified according to the operations implementing the inventive embodiments. As used herein, directory information refers to information that describes a potential candidate or voter candidate or characteristics of such candidates; for example, first and last name, age, gender, sex, geographic location, marital status, occupation, and combinations thereof. The inventive methods may include announcing the upcoming reality television, internet, or other media-based program to the public by the production team via internet, television, radio, text message, or other message transmission service, explaining how the casting process works, and directing all eligible candidates interested in auditioning to a website that has been created for the television show. Eligible candidates may comprise the public or a select group of individuals pre-selected by the studio or other entity associated with the program. The website or other interface for uploading candidate profiles may be open for a pre-set window of time in which eligible potential candidates can register, create a candidate profile, and engage in a process of gathering and seeking votes before the online polls open and during the voting. In some cases, the voting “polls” may be open from the start of the casting call when the program announcement is made, and potential candidates can begin receiving votes as soon as their profile has been created. The production team for a particular reality television show or other entity associated with the program may designate a preliminary time window before voting, and the length of that time window if used. Alternatively, potential candidates may be able to input profiles and information and voter candidates may be able to always vote and input information.

The potential candidates may input campaign profiles that serve to introduce themselves to the public, as well as the potential candidates they are competing against during the audition process. Potential candidates will be able to input photos, videos, music, and text to attract supporters. In one embodiment of the inventive method and system, all potential candidates that input information will be assigned a campaign number. Additionally, an online mailing list service may be provided to all potential candidates. The potential candidates will be able to send out an email, text, or voice message to all the web addresses and or telephone numbers they provide, asking for the recipient's vote. Along with a message, the email, text, or voice message will contain a direct link or web address to the candidate's profile on the website, and instructions on how to cast a vote for them. The email, text, or voice message will also show up in the recipient's mailbox as being sent from the sender's personal email, text, or voicemail, if the potential candidate provides their email address and telephone number. Potential candidates will also be able to seek votes by word of mouth. In some embodiments, anyone, whether they are competing or not, will be able to look up any potential candidate on the website and cast a vote for them.

In some embodiments of the invention, a specific candidate profile can be looked up on the website by the candidate's name, or campaign ID #. Candidates may call friends, family members, or even go door to door telling the people about what they are auditioning for, and asking for their vote. They may give them their campaign number, or name to look them up on the website, and tell them how the voting process/competition works. They can also ask those people who decide to support them; to campaign for them also by passing on the information to all the people they know. Supporters may campaign for their candidate via email, phone, or word of mouth.

In some embodiments of the invention, the website announcing the program and the casting competition will be available to the public. Anyone, including candidates who are auditioning themselves, can view the profiles or vote for any of the potential candidates on the website at any time during the casting process announced by the production team. The public may cast a vote for any of the potential candidates as voter candidates, whether they personally know that candidate or not. In some embodiments, anyone who is voting can cast a vote for their candidate of choice as often, and as many times as they would like. Alternatively, the number of votes, or votes per day may be limited. In an unlimited setting, a potential candidate's supporter may go on the website all day, every day, and cast votes repeatedly depending on the pre-determined set of rules. Initial candidates can be selected with closed doors or audience influence.

The voting may be organized in different ways according to different time periods or classes of persons eligible to vote depending on the reality television show, and will be at the sole discretion of the production team for that program. Alternatively, the voting may be open to a randomly selected class of persons.

In some embodiments of the inventive method and system, the production or other entity associated with the program can choose to have a preliminary time window after the casting call, where any eligible person interested in auditioning can input potential candidate information. A date may be selected for the official launch of the website, and the opening of the polls which will mark the start of the auditioning process. During the time from when the method or system begins until voter candidates may input information, only potential candidates may input information. The potential candidates will not be able to receive votes at this time, and may not be able to view any other candidate's information. The graphical user interface, or other interface where the information is inputted may only have limited features available for a limited time that only allow a potential candidate to input information, thereby creating their candidate profile. In another embodiment, voter candidates may be able to input information or receive information from a mailing service during this time. In such an embodiment, the messages generated by the mailing service may inform the recipient of the official launch date of the candidate information and when the voter candidates will be able to input information and vote for or against potential candidates. Potential candidates may be able to campaign during this time, in all the same ways, simply by informing the people they ask for support of the date, they may begin voting for them. When the date comes when voter candidates may input information, all the features of the graphical user interface or website will be available to anyone who views the site. The ability of potential candidates to input information may be excluded upon a certain date, and all the candidates who registered to audition prior to this date will now be viewable to the public. Potential candidates may still be able to request votes and promote the program.

In another embodiment, the production or other entity associated with the program may choose not to have a preliminary time window between the time at which the program is announced, and the time at which potential candidates or voter candidates may input information. In this case, a website or other interface for the program will be launched the day the production or other entity associated with the program requests potential cast members. All the features of the website or interface may be available from the first day. Eligible potential candidates will not only be able to input information, for example, register and create a candidate profile, but will be able to receive votes as information input from voter candidates as well. Potential candidates may also continue to input information; for example, register and create a candidate profile, throughout the entire course of a pre-set casting period. All the candidate profiles and information input by the potential candidates may become available to the public or to a pre-set group of people to view as soon as they are created. Voter candidates may input information; for example, the voting polls will be opened from the date of the announcement of the program or casting call and the competition may continue throughout the course of the casting process.

A date will be set that marks the end of the period where potential candidate and voter information may be inputted, thereby closing the voting polls. The predetermined number of people that the production was looking to cast and input as a baseline popularity measurement for that show will be selected by the potential candidates with the highest voter ratings. For example: If the production was looking for 100 people to cast on the television show, 100 candidates would be entered as a baseline popularity measurement, and the 100 potential candidates with the highest voter rating will be selected. The inventive method and system may or may not end there. The production team or other entity associated with the program may decide to cast the television show solely on the outcome of the method of casting based upon the potential candidates with the highest voter rating online voting, or they may also decide to invite the top candidates to an in-person audition that will take place in a designated location before the show's producers. Here, the candidates that have received the highest voter rating may audition for the production in person, and will be handpicked by the casting team or producers to be cast on the program.

In another embodiment, the production team may want 100 people to compete on a new reality show, such an amount would be entered as a baseline popularity measurement, and the 100 candidates with the highest user ratings will be cast on the program. In an alternative embodiment, the production team can say they are looking for 1000 people to audition for a show that 100 people will be cast for, and a target of 1000 potential candidates will be entered as a baseline popularity measurement. The 1000 potential candidates with the highest voter ratings will be invited to a designated time and place to audition in person. 100 people may then be chosen from the 1000 potential candidates with the highest voter ratings and cast on the program. The production can either choose to pay the travel expenses for the 1000 potential candidates invited to the in-person audition, or they may tell the people that if they honor the invite, it will be at their own expense. In case of the latter, someone who cannot afford or does not want to spend the money to travel to the audition will forfeit their spot, and the potential candidate with the next highest voter ranking will move up a spot allowing a person to take their place. Also, the potential candidates with the highest voter ratings may or may not be revealed to the public before the airing of the show.

All the embodiments may vary depending on the individual production, and will be at the discretion of the program's producers or other entities or individuals associated with the program. The inventive methods and systems benefit the production of a reality television program all around by significantly reducing the risk involved in moving forward with a show, reducing production costs, and adding convenience for the production team by selecting a subset of the population interested in being a cast member that have a built-in following or audience base by having voter candidates vote for and against the potential cast members. The method enables the production to better estimate the level of success of the show, and has the entity producing the show already making money while it is still in the pre-production stages.

When using the inventive method and system, one of the greatest costs in producing a reality show, that is, hiring a casting coordinator and casting team will be reduced because a casting coordinator/team will not be needed until the final audition, and in some cases, not needed at all. Without the inventive system and method, the casting process is a long, and expensive part of the production process for reality television. Casting calls must be made in all the cities where the production would be holding auditions. A casting team must travel to these cities, rent a location to hold the auditions, and hire security and other staff to help with the event. The auditions usually run over the course of several days. All these costs, including the travel expenses of the casting team are paid for by the production. That adds up to be a lot of money! Instead of the production team or other entity involved with the program having to go out and look for people to cast, the inventive method and system bring the people to the production. It cuts out a major expense in producing the show.

Additionally, many potential candidates are not able to attend the auditions held in several cities. The inventive system and method enable every eligible person to audition with no inconvenience to them or the production team. With a lot of these popular reality shows, the cities that hold the open auditions usually get flooded with extra congestion during them. It is an inconvenience for the regular commuters, and there is no guarantee that the people who flock to these casting calls will even be seen. A lot of times they wait in line overnight, only to be turned down from even auditioning. The inventive system and method guarantee every eligible person who wants to audition, the chance to, and takes away the disruption an open audition causes a city.

This method adds convenience for the production team because it keeps their time and focusses at their home base of operation. They do not have to worry about what is going on in different locations. This frees them up to spend more of their time on other aspects of the show, which will also save them money because they will not have to hire extra staff to take on the overflow of responsibilities.

The production or other entity associated with the program will be able to make money while still in the pre-production stage. Since the casting process will take place online, there will be a lot of internet traffic that will attract online advertisers. Selling space to advertise will bring in revenue. Instead of spending money on the casting process, the production will actually be making money on the casting process.

The internet traffic and the number of potential candidates, among other factors, will help to estimate the level of the show's success. If a large interest is being shown online, the production team can use those facts to charge more for television or internet ads when the show airs. A lack of hits on the website, or very few potential candidates, among other factors, will give the production team the option of canceling the project before it spends any real money producing it. This method maximizes profits and minimizes financial risk. This method will help with building a viewing audience. The more a reality program involves the viewing audience, the more successful it is. In view of this, the inventive method and system involve the public in the program more than ever before. The public will no longer just be helping to decide who wins the game or competition in the program, but now they will help decide who gets to play it, and if the program even airs. The inventive method and system will allow the public to feel more in control over the outcome of the program than ever before. The public will also be able to get acquainted with the potential candidates through inventive methods and systems, and the casting process by viewing their profiles. Therefore, all the candidates who get cast will already have a following. Everyone who voted on the website will also be tuning in to see if the candidates they voted for got cast, and if the candidates they voted against did not get cast. Candidates who auditioned but did not get selected will also watch the program to compare themselves to the people cast.

Production teams using the inventive method and system will also save money on promoting the show, because a lot of advertising will not be needed. The candidates that input profiles to be cast on the program, as well as the public who are taking part in the voting process, will be promoting the show. Word of mouth has always been and still is a great form of advertising and it is FREE. Due to the option of the production team also being able to invite the potential candidates with the highest voter ratings to an in-person audition; instead of just casting them on the show, producers will still have creative control over who they would like to see compete. If there is a certain type of person, they are looking for they will have the opportunity to pick them out of the finalists who travel to the in-person audition. The method will provide the production with all the benefits, but leave room for the creative professionals to cast the show in the way they see fit.

While the present invention has been described about embodiments, it is recognized that additional variations of the present invention may be devised without departing from the inventive concept. The inventive methods of pre-production and casting have industrial applicability to all events, programs, shows, concerts, and all different types of media, including television, movies, radio, internet, satellite radio, or other media yet to be created, that require selection of individuals from a large pool of potential candidates, and require a need to minimize risk and avoid wasting time and money in deciding whether or not to move forward with the event, program, show, or concert. The inventive methods can streamline the production process, including the casting process, eliminate the need to take a large risk in creating a program, initiate advertising revenue and hits, and provide a way to assess the viability and success of a show. It will further save large amounts of time and money in hiring casting coordinators, casting teams, preparation, planning, and travel.

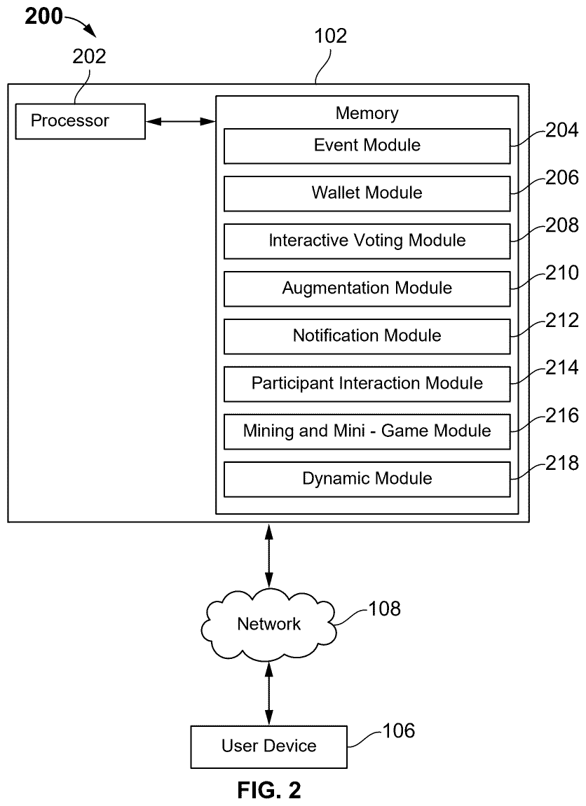

FIG. 2 exemplarily illustrates a block diagram 200 of the computing device 102 of FIG. 1. The system comprises at least one computing device 102, one or more user devices 106, and at least one database 104. The computing device 102 is in communication with the database 104 and the user devices 106 via the network 108. The user devices 106 are associated with one or more participants in communication with the television platform. The participants include the promotion team member, the contestant, one or more commentators, the production team, and one or more audiences. The audience is capable of voting for and against one or more contestants. The contestant includes, but not limited to, the influencer, the celebrity, and the public figure. The database 104 comprises multimedia data, contestant data, audience data, and audience feedback data. The computing device 102 is configured to cast and manage show content, along with the contestant activities, and the audience interactions. The computing device 102 comprises at least one memory configured to store a set of program modules and at least one processor 202 configured to execute one or more program modules. The modules comprise an event module 204, a wallet module 206, an interactive voting module 208, an augmentation module 210, a notification module 212, a participant interaction module 214, a mining and mini-game module 216, and a dynamic module 218.

The event module 204 comprises one or more events. Each event comprises one or more contestants showcasing individual talents to the audience. The wallet module 206 is configured to manage a diverse set of currencies and one or more digital assets. The currencies and the digital assets comprise one or more tokens, one or more gems, one or more cryptocurrencies, one or more non-fungible tokens (NFTs), and an inventory store. The wallet module 206 is configured to manage votes and purchase items using the tokens. The wallet module 206 is configured to manage points earned through engagement activities. The wallet module 206 is configured to be utilized for purchasing minor rewards. The wallet module 206 is configured to enable the participants to earn cryptocurrency through platform activities including purchases, mining, and secure transfer of the cryptocurrency to an external wallet module. The wallet module 206 is configured to manage ownership of the NFTs associated to the specific shows and the participants. The wallet module 206 is configured to maintain the inventory store for storing bonuses, supplies, boosters, rewards, and rebates usable within the platform and across partner platforms. The wallet module 206 comprises a cross-show currency system. The cross-show currency system is configured to enable tokens earned through participation in one show to be redeemed, transferred, and utilized across multiple franchises.

The interactive voting module 208 is configured to facilitate dynamic engagement of the participants with one or more events by casting one or more upvotes and one or more downvotes using the tokens provided on purchasing a subscription. The interactive voting module 208 is configured to enable real-time voting and provide visual feedback during the event. The interactive voting module 208 is further configured to adjust outcomes of the show based on the votes and the feedback received from the participants. The interactive voting module 208 is configured to aggregate votes of the participants instantly and displays the impact through one or more features. The features comprise a pop-up confirmation, one or more progress bars, a real-time adjustment, and an automated pre-vote.

The interactive voting module 208 is configured to provide instant feedback via the pop-up confirmation. The interactive voting module 208 is configured to display the cumulative impact of the voting effects via the progress bars. The interactive voting module 208 is configured to enable real-time adjustment of the outcomes based on the ongoing participation of the participants. The interactive voting module 208 is configured to enable the automated pre-vote process by placing the token in advance for upcoming events. The interactive voting module 208 comprises one or more voting enhancement mechanisms. The voting enhancement mechanisms comprise a fast-track voting feature and a reward-based voting feature. The fast-track voting feature is configured to enable the participants to pay and avoid one or more time-based restrictions associated with voting actions. The reward-based voting feature is configured to allow participants to enter a real-world prize drawing based on the voting activity.

The augmentation module 210 is configured to offer one or more power-up votes and a membership upgrade provided on purchasing the subscription. The power-up votes are configured to temporarily increase the voting power to enhance voting influence. The membership upgrade comprises one or more account types. The account types comprise a free account type, a basic account type, a premium account type, a very important person (VIP) account type, a promoter account type, and a celebrity account type. The augmentation module 210 is further configured to enable the participants to unlock new ranks and skills upon achieving specific milestones in the show. The augmentation module 210 is further configured to upgrade the participant profile by providing enhanced avatars, titles, and visual badges. The augmentation module 210 is further configured to offer the participants exclusive items on a time-limited and event-based basis.

The augmentation module 210 is further configured to enable one or more participants to access large token refills and enhanced features via the premium account. The augmentation module 210 is further configured to enable high-level participants to unlock top-tier rewards and faster progression via the VIP account. The augmentation module 210 is further configured to enable the contestants with a big fame to engage and influence the game using the promoter account, without claiming one or more benefits. The benefits include, but not limited to, prizes, money, and transfers.

The notification module 212 is configured to manage one or more event calendars. The notification module 212 is further configured to deliver timely updates and reminders to the participants. The notification module 212 is configured to display scheduling information for an upcoming event and voting windows. The notification module 212 is configured to send customizable alerts via a communication application. The notification module 212 is configured to provide countdown timers for the events.

The participant interaction module 214 is configured to enable the participants to create private and public chat groups associated to the specific shows. The participant interaction module 214 is further configured to access one or more sections dedicated to discussing various specific subjects related to the show. The participant interaction module 214 is further configured to enable the participants to discuss show content, form alliances, and strategize on the voting process. The participant interaction module 214 comprises a virtual reality (VR) system and an augmented reality (AR) system. The VR system is configured to enable the events to be experienced in immersive virtual reality delivering a futuristic viewing format. The VR system is configured to enhance emotional engagement. The AR system is configured to provide augmented reality overlays designed to introduce interactive elements to live events, including location-based rewards.

The mining and mini-game module 216 is configured to enable the participants to engage in a mini-game outside the television platform to earn daily rewards and one or more items. The mining and mini-game module 216 is configured to allocate a central processing unit (CPU) or a graphics processing unit (GPU) resource for the cryptocurrency mining process. The mining and mini-game module 216 is configured to manage the accumulation and automate the transfer of cryptocurrency earnings to the wallet module 206. The mining and mini-game module 216 comprises one or more bet-style prediction games. Each bet-style prediction game is configured to allow the participants to predict outcomes and win one or more bonus tokens.

The dynamic module 218 comprises one or more dynamic event challenges configured to enhance the participants engagement and participation by presenting time-bound objectives including daily tasks, weekly tasks, and supplementary tasks. The dynamic module 218 is further configured to present real-time polls comprising short and engaging questions during a live stream event to enable immediate participation of the audience. Further, the dynamic module 218 is configured to implement wagering mechanics enabling the participants to wager tokens on the outcome of the contestant. The dynamic module 218 is further configured to facilitate a barter system allowing participants to exchange one or more real-world items in a marketplace environment, thereby bypassing traditional currency-based transactions. The dynamic module 218 comprises one or more seasonal theme events including holiday themed events. The seasonal theme events are configured to ensure the show content remains engaging and interesting to the audience. The seasonal event comprises a themed week configured to enable the audience to cast the vote on a weekly basis.

The dynamic module 218 is further configured to personalize the content of the show by providing the audience with recommendations based on historical engagement, including past votes and participation data. The dynamic module 218 is further configured to introduce a wildcard contestant into the competition based on the votes of one or more fans at mid-season. The dynamic module 218 is further configured to enable the audience to vote for the contestants in a tournament-style progression format via an elimination bracket feature. The dynamic module 218 is further configured to enable the audience to create fun side challenges via an audience-designed mini-game feature.

The dynamic module 218 is further configured to allow the audience to swap the positions of two contestants within the game via a contestant switch-up feature. The dynamic module 218 is further configured to enable the audience to vote on important decisions influencing the storyline, challenges, and contestant progression in real time. The contestant progression includes, but not limited to, a performance of the contestant, wins, user contributions for the contestant, and sponsorship opportunities provided to the contestant. The dynamic module 218 is further configured to trigger a game-changing twist after a predefined number of episodes via a countdown to chaos feature. The dynamic module 218 is further configured to introduce a hidden mechanic where some votes have the opposite effect via a reverse vote mechanic. The dynamic module 218 further comprises one or more brand-sponsored in-show challenges configured to enable the audience to vote for the contestants to interact with a product of the respective brand. The brand-sponsored in-show challenges enable the participants to speed up the voting process.

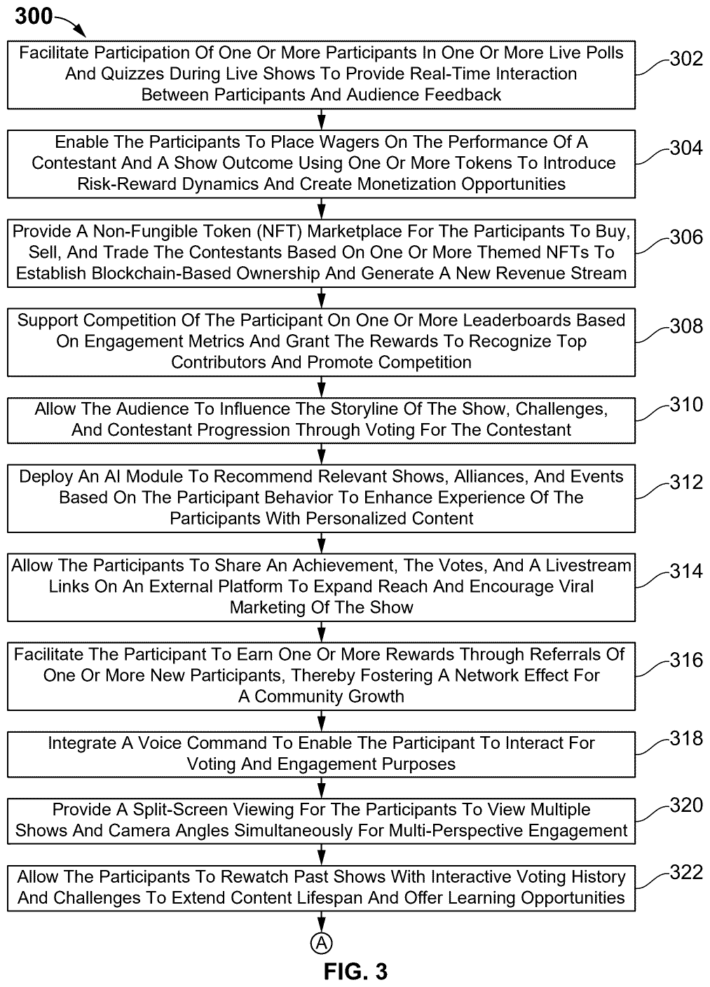

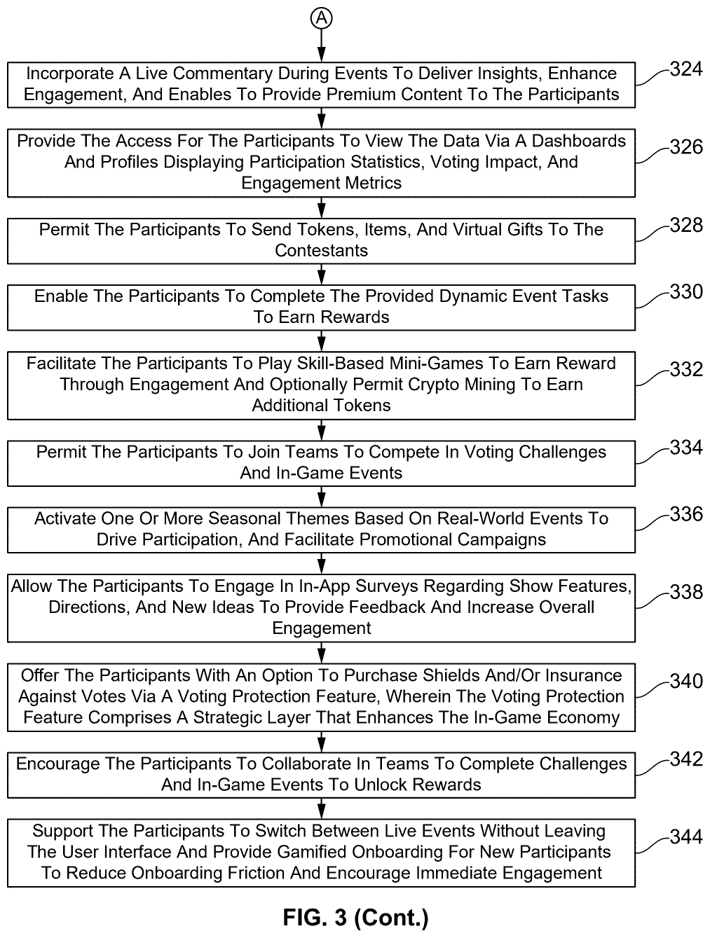

FIG. 3 illustrates a flowchart 300 of a method for conducting an interactive show, according to an embodiment of the present invention. The system comprises at least one computing device 102, at least one database 104, and one or more user devices 106. The computing device 102 is in communication with the database 104 and the user devices 106 via the network 108. The user devices 106 are associated with one or more participants in communication with the television platform. The participants include the promotion team member, the contestant, one or more commentators, the production team, and one or more audiences. The audience is capable of voting for and against one or more contestants. The database 104 comprises multimedia data, contestant data, audience data, and audience feedback data. The computing device 102 is configured to cast and manage show content, along with the contestant activities, and the audience interactions.

At step 302, the computing device 102 is configured to facilitate participation of one or more participants in one or more live polls and quizzes during live shows. The polls and quizzes are configured to provide real-time interaction between participants and audience feedback. At step 304, the computing device 102 is further configured to enable the participants to place wagers on the performance of a contestant and a show outcome using one or more tokens. The wagering introduces risk-reward dynamics and creates monetization opportunities. At step 306, the computing device 102 is further configured to provide a non-fungible token (NFT) marketplace for the participants to buy, sell, and trade the contestants based on one or more themed NFTs representing digital collectibles and in-show privileges. The NFTs establish blockchain-based ownership and generate a new revenue stream. The computing device is further configured to enable the audience to cast both upvote and downvote against the contestant to impact the progression of the event.

At step 308, the computing device 102 is further configured to support competition of the participant on one or more leaderboards based on engagement metrics. The rewards are granted to recognize top contributors and promote competition. At step 310, the computing device 102 is further configured to allow the audience to influence the storyline of the show, challenges, and contestant progression through voting for the contestant. At step 312, the computing device 102 is further configured to deploy the AI module to recommend relevant shows, alliances, and events based on the behavior of the participant. The AI module is configured to enhance the experience of the participants with personalized content.

At step 314, the computing device 102 is further configured to allow the participants to share the achievements, the votes, and the livestream links on an external platform. The external platform is configured to expand reach and encourage viral marketing of the show. At step 316, the computing device 102 is further configured to facilitate the participant to earn one or more rewards through referrals of one or more new participants, thereby fostering a network effect for community growth. At step 318, the computing device 102 is further configured to integrate a voice command to enable the participant to interact for voting and engagement purposes.

At step 320, the computing device 102 is further configured to provide split-screen viewing for the participants to view multiple shows and camera angles simultaneously for multi-perspective engagement. At step 322, the computing device 102 is further configured to allow the participants to rewatch past shows with interactive voting history and challenges to extend content lifespan and offer learning opportunities. At step 324, the computing device 102 is further configured to incorporate the live commentary during events to deliver insights, enhance engagement, and enable to provide premium content to the participants.

At step 326, the computing device 102 is further configured to provide access to the participants to view the data via a dashboard and profiles displaying participation statistics, voting impact, and engagement metrics. At step 328, the computing device 102 is further configured to permit the participants to send tokens, items, and virtual gifts to the contestants. At step 330, the computing device 102 is further configured to enable the participants to complete the provided dynamic event tasks to earn rewards. At step 332, the computing device 102 is further configured to facilitate the participants to play skill-based mini-games to earn rewards through engagement and optionally permit crypto mining to earn additional tokens. At step 334, the computing device 102 is further configured to permit the participants to join teams to compete in voting challenges and in-game events. At step 336, the computing device 102 is further configured to activate one or more seasonal themes based on real-world events to drive participation and facilitate promotional campaigns.

At step 338, the computing device 102 is further configured to allow the participants to engage in in-app surveys regarding show features, directions, and new ideas to provide feedback and increase overall engagement. At step 340, the computing device 102 is further configured to offer the participants an option to purchase shields or insurance against votes via a voting protection feature. The voting protection feature comprises a strategic layer that enhances the in-game economy. At step 342, the computing device 102 is further configured to encourage the participants to collaborate in teams to complete challenges and in-game events to unlock rewards. At step 344, the computing device 102 is further configured to support the participants to switch between live events without leaving the user interface and provide gamified onboarding for new participants to reduce onboarding friction and encourage immediate engagement.

In another embodiment, a method for casting a reality program is disclosed. The method includes displaying, by at least one server computer, a reality program over a television, the reality program having a casting competition with one or more participating contestants, storing, in a database, voting measurements input by the production team, wherein the voting. The measurements include the voting for or against each of the one or more participating contestant; and calculating, by the processor 202 associated with the server, a number of positive votes for minus a number of negative votes against each of the one or more participating contestant to generate a voter rating for each of the one or more participating contestant. The vote is either a positive vote for at least one of the one or more participating contestants or a negative vote against at least one of the one or more participating contestants.

The winner of the reality program is for at least one of the one or more participating contestant having the highest voter rating. The voter rating is influenced based on one or more tokens associated with one or more voter audiences selected from one or more voter audiences. The casting competition is influenced based on one or more tokens associated with one or more voter audiences selected from one or more voter audiences. The reality program is displayed on different medias, selected from an adequately and functionally connected TV set, internet that is able to reach certain website, radio, and a hand-held device that is able to receive and send an e-mail, to receive and send text messages and to interact successfully and adequately with any other media where the reality program is broadcasted.

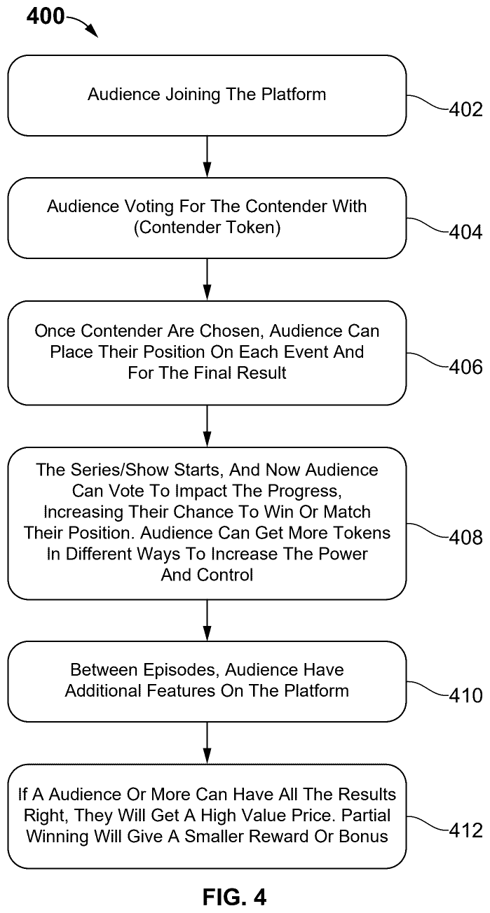

FIG. 4 exemplarily illustrates a flowchart 400 of the method for the audience voting process, according to an embodiment of the present invention. At step 402, the computing device 102 is further configured to allow the audience to join without the subscription in a passive mode. The passive mode enables the audience to view content without interaction. Once the audience purchases the subscription, the computing device 102 is configured to provide starter amount of the basic tokens to enable interaction on the platform. The computing device 102 is further configured to provide different levels of membership. The membership provides additional advantages and power for the participants to interact with and impact the shows.

At step 404, the computing devices 102 is configured to enable the audience with subscription to cast the vote to choose the contestant for a chosen show. The contender is also referred as the contestant in the entire specification. The computing device 102 is further configured to enable the contenders to introduce themselves via the user device. The computing device 102 is further configured to provide a voting window during which the audience could cast upvotes or downvotes. The voting process requires the use of tokens. The computing device 102 is further configured to allow the audiences to vote multiple times by spending additional tokens to increase the likelihood of the preferred contender being selected or eliminated. The computing device 102 is further configured to present the voting in a grid layout displaying each contender's profile or picture along with the upvote and downvote buttons. Further, one or more tokens might be spent to increase impact, and the confirmed contender is subsequently locked. Around each contender, the audience is able to see the position of the contender. Below the grid section, the audience is able to see a graph that shows what content has the most votes including who is 1st/2^{nd} and who is about to be eliminated. Some contender selection will be 1 wave of voting only, and other shows will require having multiple waves of voting.

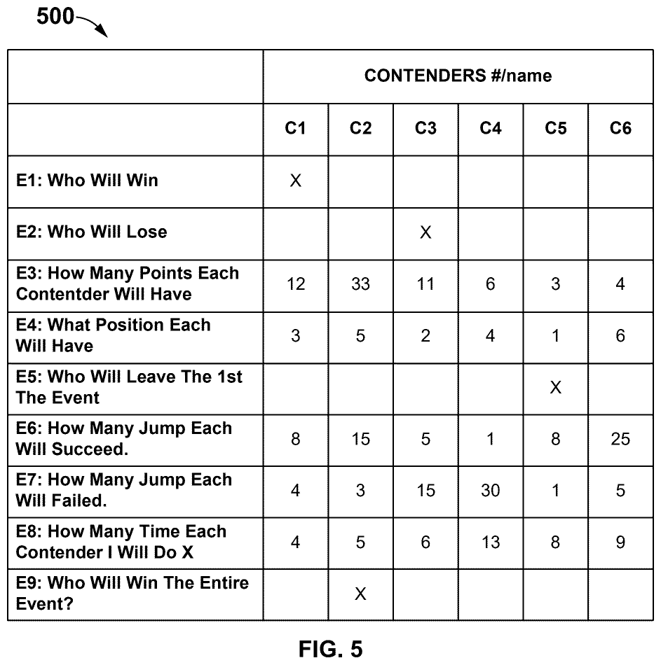

At step 406, the computing device 102 is configured to enable the audience to place the predicted contestant on the expected outcome of one or more event or challenges, once all players and contenders have been selected. FIG. 5 illustrates a table 500 showing an outcome of the multiple contenders positioned across a series of events according to voting of the audience, according to an embodiment of the present invention. Events include, but not limited to E1 to E9 representing different prediction categories within the competition. E1 specifies who might win, E2 specifies who might lose, E3 specifies how many points each contender might earn, E4 predicts the final position of each contender, E5 identifies who might be the first to leave the event, E6 predicts how many jumps each contender might successfully complete, E7 predicts how many jumps each contender might fail, E8 addresses how many times each contender might perform a specified action, and E9 identifies who might win the entire event overall. Depending on the type of event, the audience might only need to select one contender (E1, E2, E5, E9), select the correct order or rank (E4), or choose the right numerical value for each contender (E3, E6, E7, E8). After the placement timer ends, the show officially begins.

In some cases, the placement comprises one or more option including fully locked, semi locked or unlocked. In the fully locked option, the audience are unable to change positions during the entire show. In the semi-locked option, the audience might either fully change the placements at a certain moment using a special token, or adjust the positions for the remaining events only with a token. In the unlocked option, the audience could freely adjust placements for upcoming events at any time before the show is about to begin or just prior to an event taking place. The flexibility of the unlocked option depends on how quickly the production could adapt and how efficiently the live voting system responds. In one embodiment, more tokens are available to buy directly or indirectly on the platform and/or by doing some actions or achievements.

At step 408, the computing device 102 is configured to enable the audience to cast votes impacting the progression of the event once the series or show begins, thereby increasing the chance to win or improve the placement. The audience are further enabled to acquire additional tokens through different ways including sharing, participating in events, or engaging with an e-store to enhance the voting power and control. The concept of the strike votes or impact votes might take many shapes and forms. The feature, at its basic level is a window where users will be able to positively or negatively influence one or more contenders to force the event to fit their placement position in step 406, during a limited time of time. Upon expiration of the voting timer, the voting system is locked, and the information is transmitted to the production system for application to the upcoming event.

The computing device 102 is further configured to provide different types of tokens and voting mechanisms are introduced. The strike vote will be done before the episode, and the result will be shown live. Some smaller strike or impact votes will require no delay and will be able to be done live. Others that require more adjustment to the production side will require more time to be shot, edited, and uploaded. Some voting will also require endurance, until it requires watching ads or having a membership. Each show is further configured to incorporate product placement and multiple monetization opportunities for partners, content creators, and associates, as detailed in the additional monetization information. The strike vote cycle is repeated prior to each episode until the grand finale episode. Further, the computing device 102 is configured to determine and announce the final winner, if any, along with the final prize.

At step 410, the computing device 102 is configured to provide the audience with one or more features and interactive games experience after each episode. The features and interactive games including live events, special interactions, mini games, achievements, cryptocurrency mining, Augmented Reality (AR) and Virtual Reality (VR) content, special events with contenders, easter eggs, and hidden hints or information. The computing device 102 is further configured to ensure the events retain the participants engagement on the platform while offering opportunities to win small prizes and receive small monetary rewards. At step 412, the computing device 102 is configured to provide a prize to the audience who achieves a perfect placement prediction for all events. The computing device 102 is further configured to award the audience with partial correct placements a smaller prize or an internal token for further participation depending on the account type of the audience.

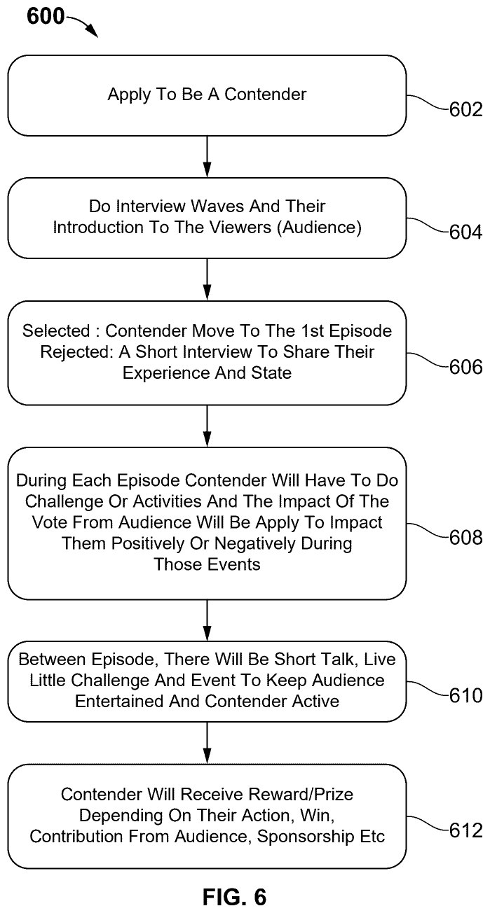

FIG. 6 exemplarily illustrates a flowchart 600 of a method for selecting and rewarding the contestant, according to an embodiment of the present invention. At step 602, the computing device 102 is configured to enable the contenders to apply for participation in the show. At step 604, the computing device 102 is configured to enable the contenders to engage in one or more interview rounds. The introductions provided in the interview round is presented to the audience to select and reject the contenders. At step 606, the computing device 102 is configured to enable the selected contenders to participate in the first episode. The computing device 102 is further configured to enable the rejected contenders to provide a short interview reflecting on the experience. At step 608, during each episode, contenders participate in challenges or activities, and apply the impact of the audience votes to positively or negatively affect contender outcomes. At step 610, the computing device 102 is configured to provide challenges including short talks, live mini-challenges, and interactive events, thereby entertaining the audience in between episodes while ensuring contenders remain active throughout. At step 612, the computing device 102 is configured to provide rewards or prizes to the contenders based on the contestant progression including performance, wins, user contributions, and sponsorship opportunities.

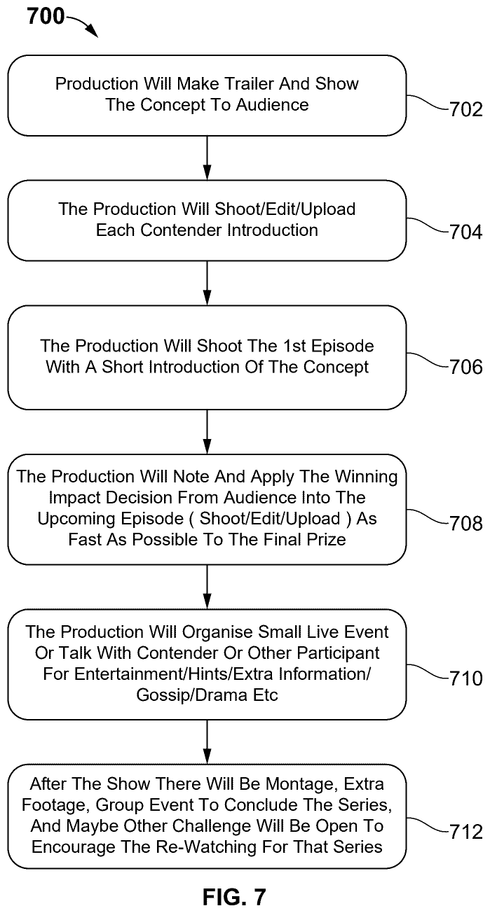

FIG. 7 exemplarily illustrates a flowchart 700 of a process involved in the internal production team, according to an embodiment of the present invention. At step 702, the computing device 102 is configured to enable the production team to present one or more trailers and an overall concept of the series to the audience. At step 704, the computing device 102 is configured to enable the production team to store the production system records, edits, and uploads contender introductions. At step 706, the computing device 102 is configured to enable the production team to create and release the first episode, which includes a short introduction of the concept. At step 708, the computing device 102 is configured to enable the production team to record and apply the winning impact decisions received from the audience into upcoming episodes as fast as possible to decide the final prize. At step 710, the computing device 102 is configured to enable the production team to organize small live events and conversations with the contenders and other participants for providing entertainment, hints, extra information, gossip, or drama to the audience. At step 712, the computing device 102 is configured to enable the production team to deliver montages, extra footage, and group events to conclude the series, with additional challenges made available to encourage re-watching the series.

Advantageously, the system is configured to engage the audience by including the real-time voting system that enable the audience to interact and directly influence the progression and outcome of the show. The heightened level of engagement fosters a more immersive and responsive entertainment experience. Further, the system provides opportunities for aspiring professionals to showcase the individual talents to a broad and diverse audience. The system empowers emerging talent to gain recognition and build a following by facilitating equal visibility and engagement. Additionally, the system supports new talents within an entertaining ecosystem that encourages creativity, audience investment, and cultural diversity.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A system for conducting an interactive show
one or more user devices associated with one or more participants in communication with a television platform, wherein the participants include a promotion team member, a contestant, one or more commentators, a production team, and one or more audiences, wherein the audiences are capable of voting for and against one or more contestants;
at least one database comprises multimedia data, contestant data, audience data, and audience feedback data;
at least one computing device in communication with the database and the user devices via a network, wherein the computing device is configured to cast and manage show content, along with the contestant activities, and the audience interactions; wherein the computing device comprises at least one memory configured to store a set of program modules and at least one processor configured to execute one or more program modules, wherein the modules comprise:
an event module comprises one or more events, wherein each event comprises one or more contestants showcasing individual talents to the audience;
a wallet module configured to manage a diverse set of currencies and one or more digital assets, wherein the currencies and the digital assets comprise one or more tokens, one or more gems, one or more cryptocurrencies, one or more non-fungible tokens (NFTs), and an inventory store, wherein the wallet module comprises a cross-show currency system, wherein the cross-show currency system is configured to enable the tokens earned in one show to be redeemed, transferred, and utilized across multiple franchises;
an interactive voting module configured to facilitate dynamic engagement of the participants with one or more events by casting one or more upvotes and one or more downvotes using the tokens provided on purchasing a subscription, wherein the interactive voting module is configured to enable real-time voting and provide visual feedback during the event, wherein the interactive voting module is further configured to adjust outcomes of the show based on the votes and the feedback received from the participants, wherein the interactive voting module is configured to aggregate votes of the participants instantly and displays the impact through one or more features, wherein the features comprise a pop-up confirmation, one or more progress bars, a real-time adjustment, and an automated pre-vote;
an augmentation module configured to offer one or more power-up votes and a membership upgrade provided on purchasing the subscription, wherein the power-up votes are configured to temporarily increase the voting power to enhance voting influence, wherein the membership upgrade comprises one or more account types, wherein the account types comprise a free account type, a basic account type, a premium account type, a very important person (VIP) account type, a promoter account type, and a celebrity account type;
a notification module configured to manage one or more event calendars, wherein the notification module is further configured to deliver timely updates and reminders to the participants, wherein the notification module is configured to display scheduling information for an upcoming event and voting windows, wherein the notification module is configured to send customizable alerts via a communication application;
a mining and mini-game module is configured to enable the participants to engage in a mini-game outside the television platform to earn daily rewards and one or more items, wherein the mining and mini-game module is configured to allocate a central processing unit (CPU) and/a graphics processing unit (GPU) resources for the cryptocurrency mining process, wherein the mining and mini-game module is configured to manage the accumulation and automate the transfer of cryptocurrency earnings to the wallet module, wherein the mining and mini-game module comprises bet-style prediction games, wherein each bet-style prediction game is configured to allow the participants to predict outcomes and win one or more bonus tokens;
a participant interaction module is configured to enable the participants to create private and public chat groups associated to the specific shows, wherein the participant interaction module is configured to access one or more sections dedicated to discussing various specific subjects related to the show, wherein the participant interaction module is configured to enable the participants to discuss show content, form alliances, and strategize on the voting process, and
a dynamic module comprises one or more dynamic event challenges configured to enhance the participants engagement and participation by presenting time-bound objectives including daily tasks, weekly tasks, and supplementary tasks, wherein the dynamic module is configured to present real-time polls comprising short and engaging questions during a live streams event to enable immediate participation of the audience, wherein the dynamic module is configured to implement wagering mechanics enabling the participants to wager tokens on the outcome of the contestant, wherein the dynamic module is configured to facilitate a barter system allowing participants to exchange one or more real-world items in a marketplace environment, thereby bypassing traditional currency-based transactions.

2. The system of claim 1, wherein the dynamic module comprises one or more seasonal theme events including holiday themed events, wherein the seasonal theme events are configured to ensure the show content remains engaging and interesting to the audience, wherein the seasonal event comprises a themed week configured to enable the audience to cast the vote on a weekly basis, wherein the dynamic module comprises one or more brand-sponsored in-show challenges configured to enable the audience to vote for the contestants to interact with a product of the respective brand, wherein the brand-sponsored in-show challenges enable the participants to speed up the voting process.

3. The system of claim 1, wherein the interactive voting module is configured to provide instant feedback via the pop-up confirmation, wherein the interactive voting module is configured to display the cumulative impact of the voting effects via the progress bars, wherein the interactive voting module is configured to enable real-time adjustment of the outcomes based on the ongoing participation of the participants, wherein the interactive voting module is configured to enable the automated pre-vote process by placing the token in advance for upcoming events.

4. The system of claim 1, wherein the wallet module is configured to manage vote and purchase items using the tokens, wherein the wallet module is configured to manage points earned through engagement activities, wherein the wallet module is configured to be utilized for purchasing minor rewards, wherein the wallet module is configured to enable the participants to earn cryptocurrency through platform activities including purchases, mining, and secure transfer of the cryptocurrency to an external wallet module, wherein the wallet module is configured to manage ownership of the NFTs associated to the specific shows and the participants, wherein the wallet module is configured to maintain the inventory store for storing bonuses, supplies, boosters, rewards, and rebates usable within the platform and across partner platforms.

5. The system of claim 1, wherein the interactive voting module comprises a fast-track voting pass and a raffle voting ticket, wherein the fast-track voting pass is configured to allows the participants to pay and avoid time restrictions on certain voting actions, wherein the raffle ticket voting is configured to enable the participants to enter real-world prize drawings based on the voting activity of the participants.

6. The system of claim 1, wherein the augmentation module is configured to:
enable the participants to unlock new ranks and skills upon achieving specific milestones in the show;
upgrade the participant profile by providing enhanced avatars, titles, and visual badges, and
offer exclusive items on a time-limited and event-based basis to the participants.

7. The system of claim 1, wherein the participant interaction module comprises a virtual reality (VR) system and an augmented reality (AR) system, wherein the VR system is configured to enable the events to be experienced in immersive virtual reality delivering a futuristic viewing format, wherein the VR system is further configured to enhance emotional engagement, wherein the AR system is configured to provide augmented reality overlays designed to introduce interactive elements to live events, including location-based rewards.

8. The system of claim 1, wherein the dynamic module is configured to:
personalize the content of the show by providing the audience with recommendations based on historical engagement, including past votes and participation data;
introduce a wildcard contestant into the competition based on the votes of one or more fans at mid-season;
enable the audience to vote for the contestants in a tournament-style progression format via an elimination bracket feature;
enable the audience to create fun side challenges via an audience-designed mini-game feature;
allow the audience to swap the positions of two contestants within the game via a contestant switch-up feature;
enable the audience to vote on the important decisions influencing the storyline, challenges, and contestant progression in real time, wherein contestant progression includes a performance of the contestant, wins, user contributions for the contestant, and sponsorship opportunities provided to the contestant;
trigger a game-changing twist after a predefined number of episodes via a countdown to chaos feature, and
introduce a hidden mechanic where some votes have the opposite effect via a reverse vote mechanic.

9. The system of claim 1, wherein the dynamic module comprises a social engagement and community is configured to:
enable groups of individuals to view the show simultaneously and cast votes together in real time;
allow the influencers to provide real-time reactions and commentary during the show;
permit the eliminated contestants to re-enter the competition based on audience support;
access and unlock exclusive content for dedicated fan bases;
allow the audience to compete based on the accuracy of the audience predictions regarding show outcomes;
represent selected audiences as a non-playable character (NPCs) within the show environment;
generate competitive dynamics between audience groups supporting opposing contestants;
grant voting privileges to verified influencers;
display real-time audience comments on the screen during the broadcast, and
trigger popular show-related memes circulating within the viewer community.

10. The system of claim 1, wherein the system further comprises an artificial intelligence (AI) module configured to curate show and event suggestions based on the activity of the participants, wherein the AI module is configured to enable adaptive challenges by customizing the experience of the audience based on engagement metrics, wherein the AI module is configured to suggest relevant shows, alliances, and events based on the behavior of the participants, wherein the AI module is configured to improve the experience of the participants with personalized content, wherein the AI module is configured to increase session duration and engagement of the participants.

11. The system of claim 1, wherein the augmentation module is configured to:
enable one or more participants to access large token refills and enhanced features via the premium account;
enable high-level participants to unlock top-tier rewards and faster progression via the VIP account, and
enable the contestants with a big fame to engage and influence the game using the promoter account, without claiming one or more benefits.

12. The system of claim 1, wherein the computing device is configured to:
utilize a voting tier mechanism to enhance voting power for the participants with a high engagement level;
enable the participants to gain compounding influence by accumulating power over multiple voting cycles using one or more cascading votes;
enable to increase of the voting power based on the duration of the engagement of the audience via a weighted voting system;
enable the audience to use special power-up votes to activate effects including a double voting and a freeze vote;
automatically trigger the event upon detecting when a predetermined percentage of the audience casts the votes in the same way in majority rules mode;
enable high-stakes voting by permitting the audience to wager tokens to influence significant events via a vote auction system;
enable the contestant to request the audience to perform specific actions in exchange for a bonus using one or more contestant-endorsed votes;
enable the audience to vote on challenges tailored to the individual contestants via one or more personalized challenge selections, and
enable the participants to purchase a personalized voting package offering customized voting options.

13. The system of claim 1, wherein the computing device is configured to:
enable the participants to purchase a one-time vote multiplier to increase vote weight during an important event;
enable the audience to boost the voting power by purchasing extra voting tokens;
utilize limited-time power-ups to temporarily increase the voting power;
enable the participants to purchase the tokens with a unique theme via a themed voting bundle;
enable risk-based voting to offer higher rewards when the chosen contestant wins;
enable the audience to temporarily block others from voting via a vote freeze power;
lock certain votes irreversibly using strategic vote locks to enforce commitment;
enable the reversible votes to adapt based on evolving in-game scenarios;
enable the contestants to use special items to swap votes using a steal-a-vote ability, and
enable the audience to solve a puzzle to unlock special voting privileges via a puzzle-based voting mechanism.

14. The system of claim 1, wherein the computing device is configured to:
enable the audience to receive a prize via a bingo-style voting reward on completing the predefined voting patterns;
enable a vote decay system to gradually reduce the power of cast votes over time unless each vote is actively reinforced by the audience;
provide an early vote bonus for the audience who votes early is granted with increased vote influence;
apply daily voting limits to restrict the number of votes the audience is allowed to submit per day;
enable the audience to divide into one or more teams, wherein each team is capable of for competing to influence different outcomes using one or more group voting challenges;
enable the random audience to decide crucial game events using a vote roulette;
enable voting via a wearable by registering smartwatch taps and gestures, and
enable the contestants to request votes in exchange for in-game favors using a bribe mode.

15. The system of claim 1, the computing device is configured to enable the audience to:
join the platform with subscription and without subscription, wherein the audience without subscription are allowed only to view the show and the audience with subscription are allowed to participate and interact with the show;
cast upvote and downvote for the contestant using one or more tokens;
position the predicted contestant on the expected outcome of one or more episode of each event;
cast votes to influence the progression of the event once the show begins, thereby increasing the likelihood of the predicted contestant winning and aligning with the expected outcome;
access one or more interactive features for continued engagement after each episode of the show, and
receive the reward upon achieving a perfect prediction of contestant placements across all events.

16. The system of claim 1, the computing device is configured to enable the production team to:
present one or more trailers and an overall concept of the series to the audience;
store the production system records, edits, and uploads contender introductions;
create and release the first episode, which includes a short introduction of the concept;
record and apply the winning impact decisions received from the audience into upcoming episodes as fast as possible to decide the final prize;
organize small live events and conversation with the contenders and other participants for providing entertainment, hints, extra information, gossip, and drama to the audience, and
deliver montages, extra footage, and group events to conclude the series, with additional challenges made available to encourage re-watching the series.

17. The system of claim 1, the computing device is configured to enable the contestant to:
apply for participation in the show;
engage in one or more interview rounds and provide the introduction, wherein the introduction provided is presented to the audience to select and reject the contenders, wherein the selected contenders are allowed to participate in the first episode and the rejected contenders are prompted to provide a short interview reflecting on their experience;
participate in challenges for each episode and the impact of the audience votes to positively or negatively affect contender outcomes, wherein the challenges comprise short talks, live mini-challenges, and interactive events to entertain the audience in between episodes while ensuring the contenders remain active throughout, and
receive the rewards based on the contestant progression including performance, wins, user contributions, and sponsorship opportunities.

18. A method for conducting an interactive show, comprising:
facilitating, at the computing device, participation of one or more participants in one or more live polls and quizzes during live shows, wherein the polls and quizzes are configured to provide real-time interaction between participants and audience feedback;
enabling, at the computing device, the participants to place wagers on the performance of a contestant and a show outcome using one or more tokens, wherein the wagering introduces risk-reward dynamics and creates monetization opportunities;
providing, at the computing device, a non-fungible token (NFT) marketplace for the participants to buy, sell, and trade the contestants based on one or more themed NFTs, wherein the NFTs establish blockchain-based ownership and generate a new revenue stream, wherein the computing device is configured to enable the audience to cast both upvote and downvote against the contestant to impact the progression of the event;
supporting, at the computing device, the competition of the participant on one or more leaderboards based on engagement metrics and granting the rewards, wherein the rewards are granted to recognize top contributors and promote competition;
allowing, at the computing device, the audience to influence the storyline of the show, challenges, and contestant progression through voting for the contestant;
deploying, at the computing device, an AI module to recommend relevant shows, alliances, and events based on the participant behavior, wherein the AI module is configured to enhance the experience of the participants with personalized content;
allowing, at the computing device, the participants to share an achievement, the votes, and one or more livestream links on an external platform, wherein the external platform is configured to expand reach and encourage viral marketing of the show;
facilitating, at the computing device, the participant to earn one or more rewards through referrals of one or more new participants, thereby fostering a network effect for community growth, and
integrating, at the computing device, a voice command to enable the participant to interact for voting and engagement purposes.

19. The method of claim 18, further comprises a step of:
providing, at the computing device, a split-screen viewing for the participants to view multiple shows and camera angles simultaneously for multi-perspective engagement;
allowing, at the computing device, the participants to rewatch past shows with interactive voting history and challenges to extend content lifespan and offer learning opportunities;
incorporating, at the computing device, a live commentary during events to deliver insights, enhance engagement, and enable to provide premium content to the participants;
providing, at the computing device, access for the participants to view the data via a dashboard and profiles displaying participation statistics, voting impact, and engagement metrics;
permitting, at the computing device, the participants to send tokens, items, and virtual gifts to the contestants;
enabling, at the computing device, the participants to complete the provided dynamic event tasks to earn rewards, and
facilitating, at the computing device, the participants to play skill-based mini-games to earn rewards through engagement and optionally permit crypto mining to earn additional tokens.

20. The method of claim 18, further comprises a step of:
permitting, at the computing device, the participants to join teams to compete in voting challenges and in-game events;
activating, at the computing device, one or more seasonal themes based on real-world events to drive participation, and facilitate promotional campaigns; and
supporting, at the computing device, the participants to switch between live events without leaving the user interface and providing gamified onboarding for new participants to reduce onboarding friction and encourage immediate engagement;
allowing, at the computing device, the participants to engage in in-app surveys regarding show features, directions, and new ideas to provide feedback and increase overall engagement;
offering, at the computing device, the participants an option to purchase shields and/or insurance against votes via a voting protection feature, wherein the voting protection feature comprises a strategic layer that enhances the in-game economy, and
encouraging, at the computing device, the participants to collaborate in teams to complete challenges and in-game events to unlock rewards.
